(19) United States
(12) Patent Application Publication
(10) Pub. No.: US 2014/0254681 A1
(43) Pub. Date: Sep. 11, 2014

(54) APPARATUS, A METHOD AND A COMPUTER PROGRAM FOR VIDEO CODING AND DECODING

(71) Applicant: Nokia Corporation, Espoo (FI)

(72) Inventors: Alireza Aminlou, Tampere (FI); Jani Lainema, Tampere (FI); Miska Matias Hannuksela, Tampere (FI)

(73) Assignee: Nokia Corporation, Espoo (FI)

(21) Appl. No.: 14/197,143

(22) Filed: Mar. 4, 2014

Related U.S. Application Data
(60) Provisional application No. 61/774,897, filed on Mar. 8, 2013.

(51) Int. Cl. H04N 19/583; H04N 19/44

(52) U.S. Cl. CPC H04N 19/00733; H04N 19/00533
USPC 375/240.16

(57) ABSTRACT

There are disclosed various methods, apparatuses and computer program products for video coding. In some embodiments motion parameters are obtained for a block of first layer samples and a first layer reference picture for the block of first layer samples is identified. A second layer reference picture corresponding to the first layer reference picture is identified, intermediate reference picture samples are derived by using sample values of the first layer reference picture and information based on sample values of the second layer reference picture, and inter-layer reference picture samples are derived by using intermediate reference picture samples and first layer samples. In some embodiments motion compensated sample values are derived from the second layer reference picture on the basis of the motion parameters; and an inter-layer reference block is derived by using residual sample values of first layer samples and motion compensated sample values from the second layer reference picture.

### TECHNICAL FIELD

The present invention relates to an apparatus, a method and a computer program for video coding and decoding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video codec may comprise an encoder which transforms input video into a compressed representation suitable for storage and/or transmission and a decoder that can uncompress the compressed video representation back into a viewable form, or either one of them. Typically, the encoder discards some information in the original video sequence in order to represent the video in a more compact form, for example at a lower bit rate.

Scalable video coding refers to coding structure where one bitstream can contain multiple representations of the content at different bitrates, resolutions or frame rates. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers.

Differential video coding refers to residual prediction approaches in scalable video coding for which motion compensation process is enhanced by utilizing differential sample values. There are two basic families of such technologies. In the first one a differential picture is formed in the decoded picture buffer (DPB), motion compensation is performed using that differential picture and the motion compensated differential samples are added to the base layer samples corresponding to the enhancement layer samples that are being predicted. The second approach forms motion compensated prediction on both base and enhancement layer, creates a differential component deducting the base layer motion compensation results from the base layer reconstructed samples and adds that differential component to the motion compensated enhancement layer samples.

### SUMMARY

Some embodiments provide a method for encoding and decoding video information. This invention proceeds from the consideration that in order to improve the performance of the enhancement layer motion compensated prediction, a special type of differential enhancement layer reference picture is made available in the decoded picture buffer for the motion compensation process. The special type of frame can also be called as an inter-layer reference frame or a high frequency inter-layer reference (HILR) frame. In some embodiments the special type of frame is generated by adding a motion compensated high frequency component from an enhancement layer to reconstructed sample values of the base layer. This may include identifying a block of base layer samples for a block of HILR frame samples; identifying base layer motion parameters for the block of base layer samples; calculating motion compensated differential prediction for the block of samples utilizing the motion parameters, sample values of a base layer reference picture and sample values of a corresponding enhancement layer reference picture; and adding the motion compensated differential prediction to the base layer samples to form a high frequency inter-layer reference frame sample block. The HILR frame sample block may be utilized as a reference in a motion compensated prediction process.

A method according to a first embodiment comprises a method for encoding a block of samples in an enhancement layer picture, the method comprising identifying a block of samples to be predicted in the enhancement layer picture; identifying a block of base layer samples for the block of enhancement layer samples; identifying base layer motion parameters for a block of base layer samples; calculating a differential block of reference samples using a base layer reference picture and the corresponding enhancement layer reference picture; performing motion compensation process on the differential block of reference samples; and creating a high frequency inter-layer reference block by adding the motion compensated differential block of reference samples to the reconstructed sample values of the block of the base layer.

Various aspects of examples of the invention are provided in the detailed description.

According to a first aspect, there is provided a method comprising:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a second aspect, there is provided a method comprising:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to a third aspect, there is provided at least one processor and at least one memory, said at least one memory stored with code thereon, which when executed by said at least one processor, causes an apparatus to perform:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a fourth aspect there is provided at least one processor and at least one memory, said at least one memory stored with code thereon, which when executed by said at least one processor, causes an apparatus to perform:

obtain motion parameters for a block of first layer samples;

identify a second layer reference picture corresponding to the first layer motion parameters;

derive a block of motion compensated sample values from the second layer reference picture on the basis of the motion parameters; and

derive an inter-layer reference block by using residual sample values of the block of first layer samples and the block of motion compensated sample values from the second layer reference picture.

According to a fifth aspect, there is provided a computer readable storage medium stored with code thereon for use by an apparatus, which when executed by a processor, causes the apparatus to perform:

obtaining motion parameters for a block of first layer samples;

identify a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a sixth aspect there is provided a computer readable storage medium stored with code thereon for use by an apparatus, which when executed by a processor, causes the apparatus to perform:

obtain motion parameters for a block of first layer samples;

identify a second layer reference picture corresponding to the first layer motion parameters;

derive a block of motion compensated sample values from the second layer reference picture on the basis of the motion parameters; and

derive an inter-layer reference block by using residual sample values of the block of first layer samples and the block of motion compensated sample values from the second layer reference picture.

According to a seventh aspect, there is provided an apparatus comprising:

means for obtaining motion parameters for a block of first layer samples;

means for identifying a first layer reference picture for the block of first layer samples on the basis of the motion parameters;

means for identifying a second layer reference picture corresponding to the first layer reference picture;

means for deriving a block of intermediate reference picture samples by using sample values of the first layer reference picture and sample values of the second layer reference picture; and

means for deriving a block of inter-layer reference samples by using the block of intermediate reference picture samples and the block of first layer samples.

According to an eighth aspect there is provided an apparatus comprising:

means for means for obtaining motion parameters for a block of first layer samples;

means for identifying a second layer reference picture corresponding to the first layer motion parameters;

means for deriving a block of motion compensated sample values from the second layer reference picture on the basis of the motion parameters; and

means for deriving an inter-layer reference block by using residual sample values of the block of first layer samples and the block of motion compensated sample values from the second layer reference picture.

According to a ninth aspect, there is provided an apparatus comprising a video encoder comprising:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference samples by using the block of intermediate reference picture samples and the block of first layer samples.

According to a tenth aspect there is provided an apparatus comprising a video encoder configured for encoding a scalable bitstream comprising at least a first layer and a second layer, wherein said video encoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to a eleventh aspect, there is provided an apparatus comprising a video decoder comprising:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer samples and sample values of the second layer reference picture; and

deriving a block of inter-layer reference samples by using the block of intermediate reference picture samples and the block of first layer samples.

According to a twelfth aspect there is provided an apparatus comprising a video decoder configured for decoding a scalable bitstream comprising at least a first layer and a second layer, wherein said video decoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to a thirteenth aspect, there is provided an encoder comprising:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a fourteenth aspect there is provided an encoder configured for encoding a scalable bitstream comprising at least a first layer and a second layer, wherein said encoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to an fifteenth aspect, there is provided a decoder comprising:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a sixteenth aspect there is provided a decoder configured for decoding a scalable bitstream comprising a base layer and at least one enhancement layer, wherein said decoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

### BRIEF DESCRIPTION OF THE DRAWINGS

For better understanding of the present invention, reference will now be made by way of example to the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4 shows schematically an encoder suitable for implementing some embodiments of the invention;

FIG. 5a shows an example of a picture consisting of two tiles;

FIG. 5b depicts an example of a current block and five spatial neighbors usable as motion prediction candidates;

FIG. 6 shows a flow chart of an encoding/decoding process according to some embodiments of the invention;

FIG. 7 shows a block chart of an encoding/decoding process according to some embodiments of the invention;

FIG. 8 shows a schematic diagram of a decoder suitable for implementing some embodiments of the invention;

FIG. 9 illustrates an example of using a high frequency inter-layer reference in motion compensated prediction according to some embodiments of the invention;

FIG. 10 illustrates another example of using a high frequency inter-layer reference in motion compensated prediction according to some embodiments of the invention; and

FIG. 11 illustrates an example of obtaining a high frequency inter-layer reference in motion compensated prediction according to some embodiments of the invention.

### DETAILED DESCRIPTION OF SOME EXAMPLE EMBODIMENTS

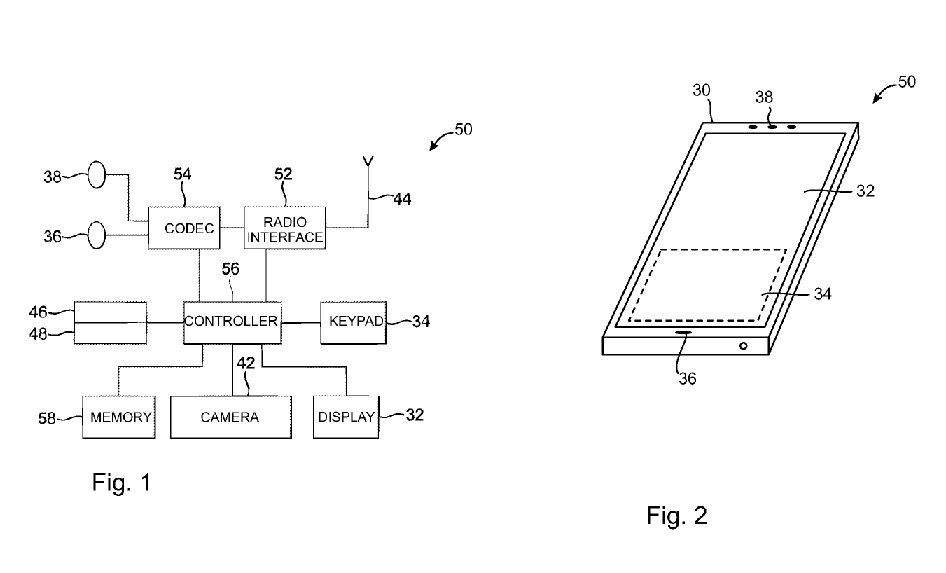

The following describes in further detail suitable apparatus and possible mechanisms for encoding an enhancement layer sub-picture without significantly sacrificing the coding efficiency. In this regard reference is first made to FIG. 1 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. The apparatus may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In other embodiments of the invention, the apparatus may receive the video image data for processing from another device prior to transmission and/or storage. In other embodiments of the invention, the apparatus 50 may receive either wirelessly or by a wired connection the image for coding/decoding.

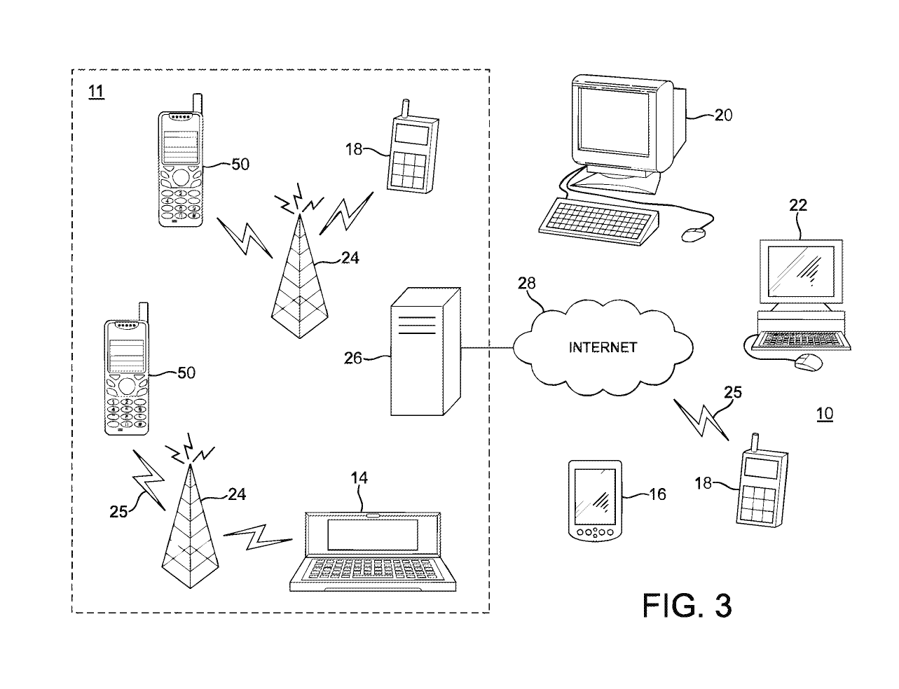

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Video codec consists of an encoder that transforms the input video into a compressed representation suited for storage/transmission and a decoder that can uncompress the compressed video representation back into a viewable form. Typically encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

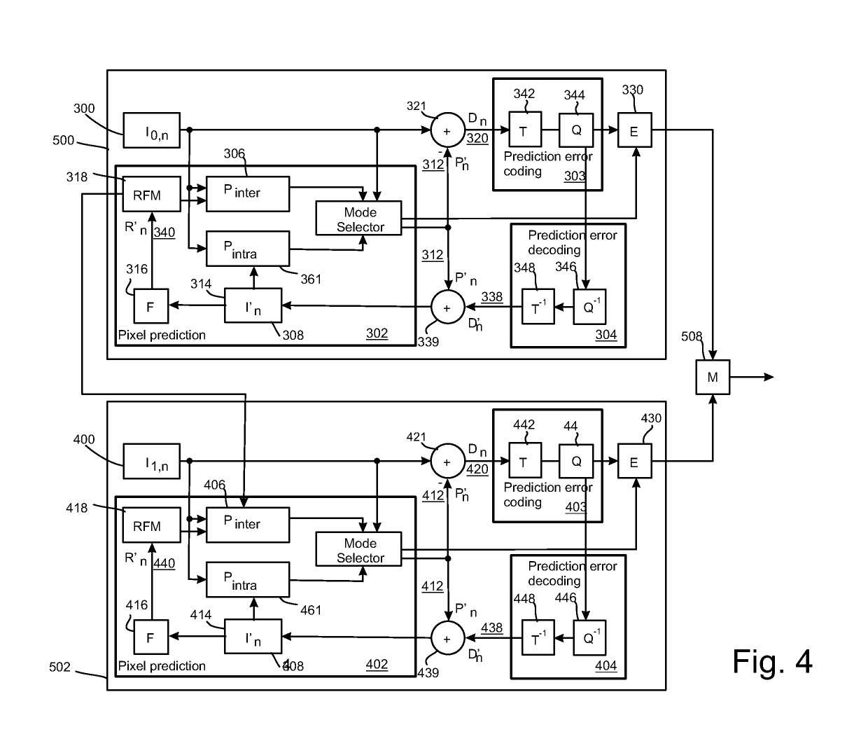

FIG. 4 shows a block diagram of a video encoder suitable for employing embodiments of the invention. FIG. 4 presents an encoder for two layers, but it would be appreciated that presented encoder could be similarly extended to encode more than two layers. FIG. 4 illustrates an embodiment of a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives 300 base layer images of a video stream to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images of a video stream to be encoded at both the inter-predictor 406 (which determines the difference between the image and a motion compensated reference frame 418) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to a filter 316, 416. The filter 316, 416 receiving the preliminary representation may filter the preliminary representation and output a final reconstructed image 340, 440 which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer pictures 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 361, 461, which dequantizes the quantized coefficient values, e.g. DCT coefficients, to reconstruct the transform signal and an inverse transformation unit 363, 463, which performs the inverse transformation to the reconstructed transform signal wherein the output of the inverse transformation unit 363, 463 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC). There is a currently ongoing standardization project of High Efficiency Video Coding (HEVC) by the Joint Collaborative Team-Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

In the description of existing standards as well as in the description of example embodiments, a syntax element may be defined as an element of data represented in the bitstream. A syntax structure may be defined as zero or more syntax elements present together in the bitstream in a specified order.

A profile may be defined as a subset of the entire bitstream syntax that is specified by a decoding/coding standard or specification. Within the bounds imposed by the syntax of a given profile it is still possible to require a very large variation in the performance of encoders and decoders depending upon the values taken by syntax elements in the bitstream such as the specified size of the decoded pictures. In many applications, it might be neither practical nor economic to implement a decoder capable of dealing with all hypothetical uses of the syntax within a particular profile. In order to deal with this issue, levels may be used. A level may be defined as a specified set of constraints imposed on values of the syntax elements in the bitstream and variables specified in a decoding/coding standard or specification. These constraints may be simple limits on values. Alternatively or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and possibly the corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In some video codecs, such as High Efficiency Video Coding (HEVC) codec, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

The directionality of a prediction mode for intra prediction, i.e. the prediction direction to be applied in a particular prediction mode, may be vertical, horizontal, diagonal. For example, in the current HEVC draft codec, unified intra prediction provides up to 34 directional prediction modes, depending on the size of PUs, and each of the intra prediction modes has a prediction direction assigned to it.

Similarly each TU is associated with information describing the prediction error decoding process for the samples within the said TU (including e.g. DCT coefficient information). It is typically signalled at CU level whether prediction error coding is applied or not for each CU. In the case there is no prediction error residual associated with the CU, it can be considered there are no TUs for the said CU. The division of the image into CUs, and division of CUs into PUs and TUs is typically signalled in the bitstream allowing the decoder to reproduce the intended structure of these units.

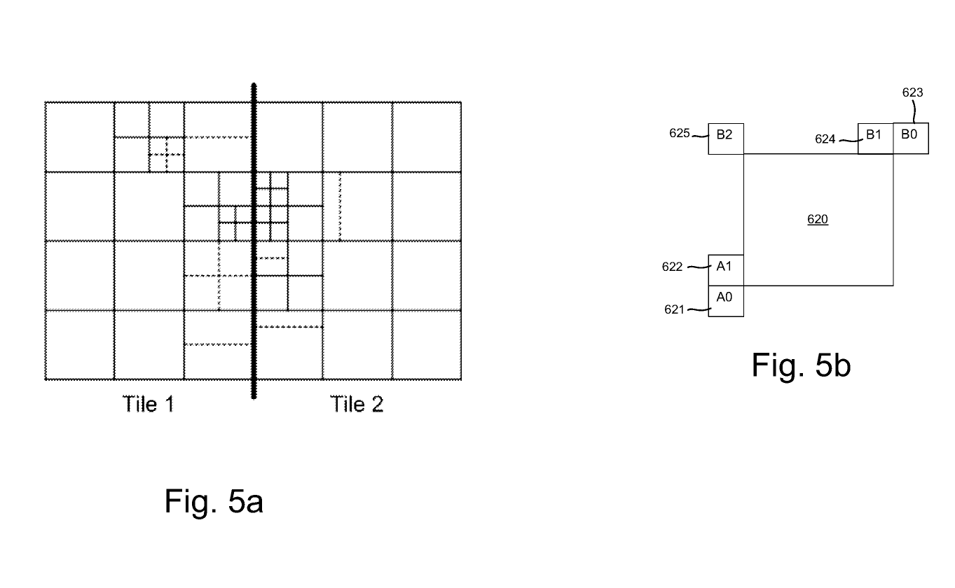

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice is defined to be an integer number of coding tree units contained in one independent slice segment and all subsequent dependent slice segments (if any) that precede the next independent slice segment (if any) within the same access unit. In a draft HEVC standard, a slice segment is defined to be an integer number of coding tree units ordered consecutively in the tile scan and contained in a single NAL unit. The division of each picture into slice segments is a partitioning. In a draft HEVC standard, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In a draft HEVC standard, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order. FIG. 5a shows an example of a picture consisting of two tiles partitioned into square coding units (solid lines) which have been further partitioned into rectangular prediction units (dashed lines).

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF).

In SAO, a picture is divided into regions where a separate SAO decision is made for each region. The SAO information in a region is encapsulated in a SAO parameters adaptation unit (SAO unit) and in HEVC, the basic unit for adapting SAO parameters is CTU (therefore an SAO region is the block covered by the corresponding CTU).

In the SAO algorithm, samples in a CTU are classified according to a set of rules and each classified set of samples are enhanced by adding offset values. The offset values are signalled in the bitstream. There are two types of offsets: 1) Band offset 2) Edge offset. For a CTU, either no SAO or band offset or edge offset is employed. Choice of whether no SAO or band or edge offset to be used may be decided by the encoder with e.g. rate distortion optimization (RDO) and signaled to the decoder.

In the band offset, the whole range of sample values is in some embodiments divided into 32 equal-width bands. For example, for 8-bit samples, width of a band is 8 (=256/32). Out of 32 bands, 4 of them are selected and different offsets are signalled for each of the selected bands. The selection decision is made by the encoder and may be signalled as follows: The index of the first band is signalled and then it is inferred that the following four bands are the chosen ones. The band offset may be useful in correcting errors in smooth regions.

In the edge offset type, the edge offset (EO) type may be chosen out of four possible types (or edge classifications) where each type is associated with a direction: 1) vertical, 2) horizontal, 3) 135 degrees diagonal, and 4) 45 degrees diagonal. The choice of the direction is given by the encoder and signalled to the decoder. Each type defines the location of two neighbour samples for a given sample based on the angle. Then each sample in the CTU is classified into one of five categories based on comparison of the sample value against the values of the two neighbour samples. The five categories are described as follows:

1. Current sample value is smaller than the two neighbour samples

2. Current sample value is smaller than one of the neighbors and equal to the other neighbor

3. Current sample value is greater than one of the neighbors and equal to the other neighbor

4. Current sample value is greater than two neighbour samples

5. None of the above

These five categories are not required to be signalled to the decoder because the classification is based on only reconstructed samples, which may be available and identical in both the encoder and decoder. After each sample in an edge offset type CTU is classified as one of the five categories, an offset value for each of the first four categories is determined and signalled to the decoder. The offset for each category is added to the sample values associated with the corresponding category. Edge offsets may be effective in correcting ringing artifacts.

The SAO parameters may be signalled as interleaved in CTU data. Above CTU, slice header contains a syntax element specifying whether SAO is used in the slice. If SAO is used, then two additional syntax elements specify whether SAO is applied to Cb and Cr components. For each CTU, there are three options: 1) copying SAO parameters from the left CTU, 2) copying SAO parameters from the above CTU, or 3) signalling new SAO parameters.

The adaptive loop filter (ALF) is another method to enhance quality of the reconstructed samples. This may be achieved by filtering the sample values in the loop. In some embodiments the encoder determines which region of the pictures are to be filtered and the filter coefficients based on e.g. RDO and this information is signalled to the decoder.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, it can be predicted which reference picture(s) are used for motion-compensated prediction and this prediction information may be represented for example by a reference index of previously coded/decoded picture. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

Typical video codecs enable the use of uni-prediction, where a single prediction block is used for a block being (de)coded, and bi-prediction, where two prediction blocks are combined to form the prediction for a block being (de)coded. Some video codecs enable weighted prediction, where the sample values of the prediction blocks are weighted prior to adding residual information. For example, multiplicative weighting factor and an additive offset which can be applied. In explicit weighted prediction, enabled by some video codecs, a weighting factor and offset may be coded for example in the slice header for each allowable reference picture index. In implicit weighted prediction, enabled by some video codecs, the weighting factors and/or offsets are not coded but are derived e.g. based on the relative picture order count (POC) distances of the reference pictures.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count (POC) difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR, (1)

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

Coded slices can be categorized into three classes: raster-scan-order slices, rectangular slices, and flexible slices.

A raster-scan-order-slice is a coded segment that consists of consecutive macroblocks or alike in raster scan order. For example, video packets of MPEG-4 Part 2 and groups of macroblocks (GOBs) starting with a non-empty GOB header in H.263 are examples of raster-scan-order slices.

A rectangular slice is a coded segment that consists of a rectangular area of macroblocks or alike. A rectangular slice may be higher than one macroblock or alike row and narrower than the entire picture width. H.263 includes an optional rectangular slice submode, and H.261 GOBs can also be considered as rectangular slices.

A flexible slice can contain any pre-defined macroblock (or alike) locations. The H.264/AVC codec allows grouping of macroblocks to more than one slice groups. A slice group can contain any macroblock locations, including non-adjacent macroblock locations. A slice in some profiles of H.264/AVC consists of at least one macroblock within a particular slice group in raster scan order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit. In H.264/AVC, the NAL unit header indicates whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The NAL unit header contains one reserved bit, a six-bit NAL unit type indication, a three-bit nuh_temporal_id_plus1 indication for temporal level (may be required to be greater than or equal to 1) and a six-bit reserved field (called reserved_zero_{—}6 bits). The temporal_id syntax element may be regarded as a temporal identifier for the NAL unit, and a zero-based Temporand variable may be derived as follows: Temporand=temporal_id_plus1-1. Temporand equal to 0 corresponds to the lowest temporal level. The value of temporal_id_plus1 is required to be non-zero in order to avoid start code emulation involving the two NAL unit header bytes.

The six-bit reserved field is expected to be used by extensions such as a future scalable and 3D video extension. It is expected that these six bits would carry information on the scalability hierarchy, such as quality_id or similar, dependency_id or similar, any other type of layer identifier, view order index or similar, view identifier, an identifier similar to priority_id of SVC indicating a valid sub-bitstream extraction if all NAL units greater than a specific identifier value are removed from the bitstream. Without loss of generality, in some example embodiments a variable LayerId is derived from the value of reserved_zero_{—}6 bits for example as follows: LayerId=reserved_zero_{—}6 bits. In some designs for scalable extensions of HEVC, such as in the document JCTVC-K1007, reserved_zero_{—}6 bits are replaced by a layer identifier field e.g. referred to as nuh_layer_id. In the following, LayerId, nuh_layer_id and layer_id are used interchangeably unless otherwise indicated.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU.

In H.264/AVC, a coded slice NAL unit can be indicated to be a coded slice in an Instantaneous Decoding Refresh (IDR) picture or coded slice in a non-IDR picture.

In HEVC, a coded slice NAL unit can be indicated to be one of the following types:

| | Name of | Content of NAL unit and RBSP |
|---|---|---|
| nal_unit_type | nal_unit_type | syntax structure |
| 0, | TRAIL_N, | Coded slice segment of a non-TSA, |
| 1 | TRAIL_R | non-STSA trailing picture |
| | | slice_segment_layer_rbsp( ) |
| 2, | TSA_N, | Coded slice segment of a TSA picture |
| 3 | TSA_R | slice_segment_layer_rbsp( ) |
| 4, | STSA_N, | Coded slice segment of an STSA |
| 5 | STSA_R | picture |
| | | slice_layer_rbsp( ) |
| 6, | RADL_N, | Coded slice segment of a RADL |
| 7 | RADL_R | picture |
| | | slice_layer_rbsp( ) |
| 8, | RASL_N, | Coded slice segment of a RASL |
| 9 | RASL_R, | picture |
| | | slice_layer_rbsp( ) |
| 10, | RSV_VCL_N10 | Reserved // reserved non-RAP non- |
| 12, | RSV_VCL_N12 | reference VCL NAL unit types |
| 14 | RSV_VCL_N14 | |
| 11, | RSV_VCL_R11 | Reserved // reserved non-RAP |
| 13, | RSV_VCL_R13 | reference VCL NAL unit types |
| 15 | RSV_VCL_R15 | |
| 16, | BLA_W_LP | Coded slice segment of a BLA picture |
| 17, | BLA_W_DLP | slice_segment_layer_rbsp( ) [Ed. |
| 18 | BLA_N_LP | (YK): BLA_W_DLP -> |
| | BLA_W_RADL | BLA_W_RADL?] |
| 19, | IDR_W_DLP | Coded slice segment of an IDR |
| 20 | IDR_N_LP | picture |
| | | slice_segment_layer_rbsp( ) |
| 21 | CRA_NUT | Coded slice segment of a CRA |
| | | picture |
| | | slice_segment_layer_rbsp( ) |
| 22, | RSV_RAP_VCL22.. | Reserved // reserved RAP VCL NAL |
| 23 | RSV_RAP_VCL23 | unit types |
| 24..31 | RSV_VCL24.. | Reserved // reserved non-RAP VCL |
| | RSV_VCL31 | NAL unit types |

In a draft HEVC standard, abbreviations for picture types may be defined as follows: trailing (TRAIL) picture, Temporal Sub-layer Access (TSA), Step-wise Temporal Sub-layer Access (STSA), Random Access Decodable Leading (RADL) picture, Random Access Skipped Leading (RASL) picture, Broken Link Access (BLA) picture, Instantaneous Decoding Refresh (IDR) picture, Clean Random Access (CRA) picture.

A Random Access Point (RAP) picture is a picture where each slice or slice segment has nal_unit_type in the range of 16 to 23, inclusive. A RAP picture contains only intra-coded slices, and may be a BLA picture, a CRA picture or an IDR picture. The first picture in the bitstream is a RAP picture. Provided the necessary parameter sets are available when they need to be activated, the RAP picture and all subsequent non-RASL pictures in decoding order can be correctly decoded without performing the decoding process of any pictures that precede the RAP picture in decoding order. There may be pictures in a bitstream that contain only intra-coded slices that are not RAP pictures.

In HEVC a CRA picture may be the first picture in the bitstream in decoding order, or may appear later in the bitstream. CRA pictures in HEVC allow so-called leading pictures that follow the CRA picture in decoding order but precede it in output order. Some of the leading pictures, so-called RASL pictures, may use pictures decoded before the CRA picture as a reference. Pictures that follow a CRA picture in both decoding and output order are decodable if random access is performed at the CRA picture, and hence clean random access is achieved similarly to the clean random access functionality of an IDR picture.

A CRA picture may have associated RADL or RASL pictures. When a CRA picture is the first picture in the bitstream in decoding order, the CRA picture is the first picture of a coded video sequence in decoding order, and any associated RASL pictures are not output by the decoder and may not be decodable, as they may contain references to pictures that are not present in the bitstream.

A leading picture is a picture that precedes the associated RAP picture in output order. The associated RAP picture is the previous RAP picture in decoding order (if present). A leading picture is either a RADL picture or a RASL picture.

All RASL pictures are leading pictures of an associated BLA or CRA picture. When the associated RAP picture is a BLA picture or is the first coded picture in the bitstream, the RASL picture is not output and may not be correctly decodable, as the RASL picture may contain references to pictures that are not present in the bitstream. However, a RASL picture can be correctly decoded if the decoding had started from a RAP picture before the associated RAP picture of the RASL picture. RASL pictures are not used as reference pictures for the decoding process of non-RASL pictures. When present, all RASL pictures precede, in decoding order, all trailing pictures of the same associated RAP picture. In some earlier drafts of the HEVC standard, a RASL picture was referred to a Tagged for Discard (TFD) picture.

All RADL pictures are leading pictures. RADL pictures are not used as reference pictures for the decoding process of trailing pictures of the same associated RAP picture. When present, all RADL pictures precede, in decoding order, all trailing pictures of the same associated RAP picture. RADL pictures do not refer to any picture preceding the associated RAP picture in decoding order and can therefore be correctly decoded when the decoding starts from the associated RAP picture. In some earlier drafts of the HEVC standard, a RADL picture was referred to a Decodable Leading Picture (DLP).

When a part of a bitstream starting from a CRA picture is included in another bitstream, the RASL pictures associated with the CRA picture might not be correctly decodable, because some of their reference pictures might not be present in the combined bitstream. To make such a splicing operation straightforward, the NAL unit type of the CRA picture can be changed to indicate that it is a BLA picture. The RASL pictures associated with a BLA picture may not be correctly decodable hence are not be output/displayed. Furthermore, the RASL pictures associated with a BLA picture may be omitted from decoding.

A BLA picture may be the first picture in the bitstream in decoding order, or may appear later in the bitstream. Each BLA picture begins a new coded video sequence, and has similar effect on the decoding process as an IDR picture. However, a BLA picture contains syntax elements that specify a non-empty reference picture set. When a BLA picture has nal_unit_type equal to BLA_W_LP, it may have associated RASL pictures, which are not output by the decoder and may not be decodable, as they may contain references to pictures that are not present in the bitstream. When a BLA picture has nal_unit_type equal to BLA_W_LP, it may also have associated RADL pictures, which are specified to be decoded. When a BLA picture has nal_unit_type equal to BLA_W_DLP, it does not have associated RASL pictures but may have associated RADL pictures, which are specified to be decoded. When a BLA picture has nal_unit_type equal to BLA_N_LP, it does not have any associated leading pictures.

An IDR picture having nal_unit_type equal to IDR_N_LP does not have associated leading pictures present in the bitstream. An IDR picture having nal_unit_type equal to IDR_W_LP does not have associated RASL pictures present in the bitstream, but may have associated RADL pictures in the bitstream.

When the value of nal_unit_type is equal to TRAIL_N, TSA_N, STSA_N, RADL_N, RASL_N, RSV_VCL_N10, RSV_VCL_N12, or RSV_VCL_N14, the decoded picture is not used as a reference for any other picture of the same temporal sub-layer. That is, in a draft HEVC standard, when the value of nal_unit_type is equal to TRAIL_N, TSA_N, STSA_N, RADL_N, RASL_N, RSV_VCL_N10, RSV_VCL_N12, or RSV_VCL_N14, the decoded picture is not included in any of RefPicSetStCurrBefore, RefPicSetStCurrAfter and RefPicSetLtCurr of any picture with the same value of TemporalId. A coded picture with nal_unit_type equal to TRAIL_N, TSA_N, STSA_N, RADL_N, RASL_N, RSV_VCL_N10, RSV_VCL_N12, or RSV_VCL_N14 may be discarded without affecting the decodability of other pictures with the same value of TemporalId.

A trailing picture may be defined as a picture that follows the associated RAP picture in output order. Any picture that is a trailing picture does not have nal_unit_type equal to RADL_N, RADL_R, RASL_N or RASL_R. Any picture that is a leading picture may be constrained to precede, in decoding order, all trailing pictures that are associated with the same RAP picture. No RASL pictures are present in the bitstream that are associated with a BLA picture having nal_unit_type equal to BLA_W_DLP or BLA_N_LP. No RADL pictures are present in the bitstream that are associated with a BLA picture having nal_unit_type equal to BLA_N_LP or that are associated with an IDR picture having nal_unit_type equal to IDR_N_LP. Any RASL picture associated with a CRA or BLA picture may be constrained to precede any RADL picture associated with the CRA or BLA picture in output order. Any RASL picture associated with a CRA picture may be constrained to follow, in output order, any other RAP picture that precedes the CRA picture in decoding order.

In HEVC there are two picture types, the TSA and STSA picture types that can be used to indicate temporal sub-layer switching points. If temporal sub-layers with TemporalId up to N had been decoded until the TSA or STSA picture (exclusive) and the TSA or STSA picture has TemporalId equal to N+1, the TSA or STSA picture enables decoding of all subsequent pictures (in decoding order) having TemporalId equal to N+1. The TSA picture type may impose restrictions on the TSA picture itself and all pictures in the same sub-layer that follow the TSA picture in decoding order. None of these pictures is allowed to use inter prediction from any picture in the same sub-layer that precedes the TSA picture in decoding order. The TSA definition may further impose restrictions on the pictures in higher sub-layers that follow the TSA picture in decoding order. None of these pictures is allowed to refer a picture that precedes the TSA picture in decoding order if that picture belongs to the same or higher sub-layer as the TSA picture. TSA pictures have TemporalId greater than 0. The STSA is similar to the TSA picture but does not impose restrictions on the pictures in higher sub-layers that follow the STSA picture in decoding order and hence enable up-switching only onto the sub-layer where the STSA picture resides.

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. In a draft HEVC standard a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In a draft HEVC, there is also a third type of parameter sets, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS. In another draft HEVC standard, an APS syntax structure only contains ALF parameters. In a draft HEVC standard, an adaptation parameter set RBSP includes parameters that can be referred to by the coded slice NAL units of one or more coded pictures when at least one of sample_adaptive_offset_enabled_flag or adaptive_loop_filter_enabled_flag are equal to 1. In some later drafts of HEVC, the APS syntax structure was removed from the specification text.

A draft HEVC standard also includes a fourth type of a parameter set, called a video parameter set (VPS), which was proposed for example in document JCTVC-H0388 (http://phenix.int-evry.fr/jct/doc_end_user/documents/8_San %20Jose/wg11/JCTVC-H0388-v4.zip). A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3DV. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. In a scalable extension of HEVC, VPS may for example include a mapping of the LayerId value derived from the NAL unit header to one or more scalability dimension values, for example correspond to dependency_id, quality_id, view_id, and depth_flag for the layer defined similarly to SVC and MVC. VPS may include profile and level information for one or more layers as well as the profile and/or level for one or more temporal sub-layers (consisting of VCL NAL units at and below certain temporal_id values) of a layer representation.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a draft HEVC standard, a slice header additionally contains an APS identifier, although in some later drafts of the HEVC standard the APS identifier was removed from the slice header. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter set may be activated by a reference from a slice or from another active parameter set or in some cases from another syntax structure such as a buffering period SEI message.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

In H.264/AVC, a coded video sequence is defined to be a sequence of consecutive access units in decoding order from an IDR access unit, inclusive, to the next IDR access unit, exclusive, or to the end of the bitstream, whichever appears earlier. In a draft HEVC standard, a coded video sequence is defined to be a sequence of access units that consists, in decoding order, of a CRA access unit that is the first access unit in the bitstream, an IDR access unit or a BLA access unit, followed by zero or more non-IDR and non-BLA access units including all subsequent access units up to but not including any subsequent IDR or BLA access unit.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, can be used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP may be considered to start from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in a draft HEVC standard, a combined list (List C) is constructed after the final reference picture lists (List 0 and List 1) have been constructed. The combined list may be used for uni-prediction (also known as uni-directional prediction) within B slices. In some later drafts of the HEVC standard, the combined list was removed.

A reference picture list, such as reference picture list 0 and reference picture list 1, may be constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. In H.264/AVC, the RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. In HEVC, the initial reference picture lists may be modified through the reference picture list modification syntax structure, where pictures in the initial reference picture lists may be identified through an entry index to the list. In other words, in HEVC, reference picture list modification is encoded into a syntax structure comprising a loop over each entry in the final reference picture list, where each loop entry is a fixed-length coded index to the initial reference picture list and indicates the picture in ascending position order in the final reference picture list.

Scalable video coding refers to coding structure where one bitstream can contain multiple representations of the content at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in selected reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The advanced motion vector prediction (AMVP) may operate for example as follows, while other similar realizations of advanced motion vector prediction are also possible for example with different candidate position sets and candidate locations with candidate position sets. Two spatial motion vector predictors (MVPs) may be derived and a temporal motion vector predictor (TMVP) may be derived. They may be selected among the positions shown in FIG. 5b three spatial motion vector predictor candidate positions 623, 624, 625 located above the current prediction block 620 (B0, B1, B2) and two 621, 622 on the left (A0, A1). The first motion vector predictor that is available (e.g. resides in the same slice, is inter-coded, etc.) in a pre-defined order of each candidate position set, (B0, B1, B2) or (A0, A1), may be selected to represent that prediction direction (up or left) in the motion vector competition. A reference index for the temporal motion vector predictor may be indicated by the encoder in the slice header (e.g. as a collocated_ref_idx syntax element). The motion vector obtained from the co-located picture may be scaled according to the proportions of the picture order count differences of the reference picture of the temporal motion vector predictor, the co-located picture, and the current picture. Moreover, a redundancy check may be performed among the candidates to remove identical candidates, which can lead to the inclusion of a zero motion vector in the candidate list. The motion vector predictor may be indicated in the bitstream for example by indicating the direction of the spatial motion vector predictor (up or left) or the selection of the temporal motion vector predictor candidate.

In addition to predicting the motion vector values, the reference index of previously coded/decoded picture can be predicted. The reference index may be predicted from adjacent blocks and/or from co-located blocks in a temporal reference picture.

Many high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU may comprise one or more of the following: 1) The information whether ‘the PU is uni-predicted using only reference picture list0’ or ‘the PU is uni-predicted using only reference picture list 1’ or ‘the PU is bi-predicted using both reference picture list0 and list 1’; 2) Motion vector value corresponding to the reference picture list0 which may comprise a horizontal and vertical motion vector component; 3) Reference picture index in the reference picture list0 and/or an identifier of a reference picture pointed to by the motion vector corresponding to reference picture list0 where the identifier of a reference picture may be for example a picture order count value, a layer identifier value (for inter-layer prediction), or a pair of a picture order count value and a layer identifier value; 4) Information of the reference picture marking of the reference picture, e.g. information whether the reference picture was marked as “used for short-term reference” or “used for long-term reference”; 5)-7) The same as 2)-4), respectively, but for reference picture list 1. Similarly, predicting the motion information is carried out using the motion information of adjacent blocks and/or co-located blocks in temporal reference pictures. A list, often called as a merge list, may be constructed by including motion prediction candidates associated with available adjacent/co-located blocks and the index of selected motion prediction candidate in the list is signalled and the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism may also be employed for individual PUs (not necessarily the whole CU as in skip mode) and in this case, prediction residual may be utilized to improve prediction quality. This type of prediction mode is typically named as an inter-merge mode.

One of the candidates in the merge list may be a TMVP candidate, which may be derived from the collocated block within an indicated or inferred reference picture, such as the reference picture indicated for example in the slice header for example using the collocated_ref_idx syntax element or alike

In HEVC the so-called target reference index for temporal motion vector prediction in the merge list is set as 0 when the motion coding mode is the merge mode. When the motion coding mode in HEVC utilizing the temporal motion vector prediction is the advanced motion vector prediction mode, the target reference index values are explicitly indicated (e.g. per each PU).

When the target reference index value has been determined, the motion vector value of the temporal motion vector prediction may be derived as follows: Motion vector at the block that is co-located with the bottom-right neighbor of the current prediction unit is calculated. The picture where the co-located block resides may be e.g. determined according to the signaled reference index in the slice header as described above. The determined motion vector at the co-located block is scaled with respect to the ratio of a first picture order count difference and a second picture order count difference. The first picture order count difference is derived between the picture containing the co-located block and the reference picture of the motion vector of the co-located block. The second picture order count difference is derived between the current picture and the target reference picture. If one but not both of the target reference picture and the reference picture of the motion vector of the co-located block is a long-term reference picture (while the other is a short-term reference picture), the TMVP candidate may be considered unavailable. If both of the target reference picture and the reference picture of the motion vector of the co-located block are long-term reference pictures, no POC-based motion vector scaling may be applied.

In some scalable video coding schemes, a video signal can be encoded into a base layer and one or more enhancement layers. An enhancement layer may enhance the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Some coding standards allow creation of scalable bit streams. A meaningful decoded representation can be produced by decoding only certain parts of a scalable bit stream. Scalable bit streams can be used for example for rate adaptation of pre-encoded unicast streams in a streaming server and for transmission of a single bit stream to terminals having different capabilities and/or with different network conditions. A list of some other use cases for scalable video coding can be found in the ISO/IEC JTC1 SC29 WG11 (MPEG) output document N5540, “Applications and Requirements for Scalable Video Coding”, the 64^{th} MPEG meeting, Mar. 10 to 14, 2003, Pattaya, Thailand.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS).

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

A scalable video encoder e.g. for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, block partitioning, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop may be needed for decoding of most pictures, while a second decoding loop may be selectively applied to reconstruct the base representations, which may be needed as prediction references but not for output or display, and may be reconstructed only for the so called key pictures (for which “store_ref base_pic_flag” is equal to 1).

FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

The scalability structure in the SVC draft may be characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL-1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_ref active_{—}1x_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use typically with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In all of the above scalability cases, base layer information could be used to code enhancement layer to minimize the additional bitrate overhead.

Scalability can be enabled in two basic ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame based scalability, approach can be implemented very efficiently with minimal changes to single layer codecs while still achieving majority of the coding efficiency gains available. Essentially a reference frame based scalability codec can be implemented by utilizing the same hardware or software implementation for all the layers, just taking care of the DPB management by external means.

In scalable multiview coding, the same bitstream may contain coded view components of multiple views and at least some coded view components may be coded using quality and/or spatial scalability.

The multiview extension of HEVC, referred to as MV-HEVC, is similar to the MVC extension of H.264/AVC. Similarly to MVC, in MV-HEVC, inter-view reference pictures can be included in the reference picture list(s) of the current picture being coded or decoded. The scalable extension of HEVC, referred to as SHVC, is planned to be specified so that it uses multi-loop decoding operation (unlike the SVC extension of H.264/AVC). Currently, two designs to realize scalability are investigated for SHVC. One is reference index based, where an inter-layer reference picture can be included in one or more reference picture lists of the current picture being coded or decoded (as described above). Another may be referred to as IntraBL or TextureRL, where a specific coding mode, e.g. in CU level, is used for using decoded/reconstructed sample values of a reference layer picture for prediction in an enhancement layer picture. The SHVC development has concentrated on development of spatial and coarse grain quality scalability.

It may be possible to use many of the same syntax structures, semantics, and decoding processes for MV-HEVC and reference-index-based SHVC. Furthermore, it may be possible to use the same syntax structures, semantics, and decoding processes for depth coding too. Hereafter, the term scalable multiview extension of HEVC (SMV-HEVC) is used to refer to a coding process, a decoding process, syntax, and semantics where largely the same (de)coding tools may be used regardless of the scalability type and where the reference index based approach without changes in the syntax, semantics, or decoding process below the slice header is used. SMV-HEVC might not be limited to multiview, spatial, and coarse grain quality scalability but may also support other types of scalability, such as depth-enhanced video.

For the enhancement layer coding, the same concepts and coding tools of HEVC may be used in SHVC, MV-HEVC, and/or SMV-HEVC. However, the additional inter-layer prediction tools, which employ already coded data (including reconstructed picture samples and motion parameters a.k.a motion information) in reference layer for efficiently coding an enhancement layer, may be integrated to SHVC, MV-HEVC, and/or SMV-HEVC codec.

In MV-HEVC, SMV-HEVC, and reference index based SHVC solution, the block level syntax and decoding process are not changed for supporting inter-layer texture prediction. Only the high-level syntax has been modified (compared to that of HEVC) so that reconstructed pictures (upsampled if necessary) from a reference layer of the same access unit can be used as the reference pictures for coding the current enhancement layer picture. The inter-layer reference pictures as well as the temporal reference pictures may be included in the reference picture lists. The signaled reference picture index is used to indicate whether the current Prediction Unit (PU) is predicted from a temporal reference picture or an inter-layer reference picture. The use of this feature may be controlled by the encoder and indicated in the bitstream, for example in a video parameter set, a sequence parameter set, a picture parameter, and/or a slice header. The indication(s) may be specific to an enhancement layer, a reference layer, a pair of an enhancement layer and a reference layer, specific TemporalId values, specific picture types (e.g. RAP pictures), specific slice types (e.g. P and B slices but not I slices), pictures of a specific POC value, and/or specific access units, for example. The scope and/or persistence of the indication(s) may be indicated along with the indication(s) themselves and/or may be inferred.

The reference list(s) in MV-HEVC, SMV-HEVC, and a reference index based SHVC solution may be initialized using a specific process in which the inter-layer reference picture(s), if any, may be included in the initial reference picture list(s). The reference list(s) may be constructed as follows. For example, the temporal references may firstly be added into the reference lists (L0, L1) in the same manner as the reference list construction in HEVC. After that, the inter-layer references may be added after the temporal references. The inter-layer reference pictures may be, for example, concluded from the layer dependency information, such as the RefLayerId[i] variable derived from the VPS extension as described above. The inter-layer reference pictures may be added to the initial reference picture list L0 if the current enhancement-layer slice is a P-Slice, and may be added to both initial reference picture lists L0 and L1 if the current enhancement-layer slice is a B-Slice. The inter-layer reference pictures may be added to the reference picture lists in a specific order, which can but need not be the same for both reference picture lists. For example, an opposite order of adding inter-layer reference pictures into the initial reference picture list L1 may be used compared to that of the initial reference picture list L0. For example, inter-layer reference pictures may be inserted into the initial reference picture list L0 in an ascending order of nuh_layer_id, while an opposite order may be used to initialize the initial reference picture list L1.

In the coding and/or decoding process, the inter-layer reference pictures may be treated as long term reference pictures.

In SMV-HEVC and a reference index based SHVC solution, inter-layer motion parameter prediction may be performed by setting the inter-layer reference picture as the collocated reference picture for a temporal motion vector prediction (TMVP) derivation. A motion field mapping process between two layers may be performed for example to avoid block level decoding process modification in TMVP derivation. A motion field mapping could also be performed for multiview coding, but a present draft of MV-HEVC does not include such a process. The use of the motion field mapping feature may be controlled by the encoder and indicated in the bitstream, for example in a video parameter set, a sequence parameter set, a picture parameter, and/or a slice header. The indication(s) may be specific to an enhancement layer, a reference layer, a pair of an enhancement layer and a reference layer, specific TemporalId values, specific picture types (e.g. RAP pictures), specific slice types (e.g. P and B slices but not I slices), pictures of a specific POC value, and/or specific access units, for example. The scope and/or persistence of the indication(s) may be indicated along with the indication(s) themselves and/or may be inferred.

In a motion field mapping process for spatial scalability, the motion field of the upsampled inter-layer reference picture is attained based on the motion field of the respective reference layer picture. The motion parameters (which may e.g. include a horizontal and/or vertical motion vector value and a reference index) and/or a prediction mode for each block of the upsampled inter-layer reference picture may be derived from the corresponding motion parameters and/or prediction mode of the collocated block in the reference layer picture. The block size used for the derivation of the motion parameters and/or prediction mode in the upsampled inter-layer reference picture may be, for example, 16×16. The 16×16 block size is the same as in HEVC TMVP derivation process where compressed motion field of reference picture is used.

Other types of scalability and scalable video coding include bit-depth scalability, where base layer pictures are coded at lower bit-depth (e.g. 8 bits) per luma and/or chroma sample than enhancement layer pictures (e.g. 10 or 12 bits), chroma format scalability, where base layer pictures may provide higher fidelity and/or higher spatial resolution in chroma (e.g. coded in 4:4:4 chroma format) than enhancement layer pictures (e.g. 4:2:0 format), and color gamut scalability, where the enhancement layer pictures may have a richer/broader color representation range than that of the base layer pictures—for example the enhancement layer may have UHDTV (ITU-R BT.2020) color gamut and the base layer may have the ITU-R BT.709 color gamut. Any number of such other types of scalability may be realized for example with a reference index based approach as described above.

Differential video coding refers to residual prediction approaches in scalable video coding for which motion compensation process is enhanced by utilizing differential sample values. There are two basic families of such technologies. In the first one a differential picture is formed in the decoded picture buffer (DPB), motion compensation is performed using that differential picture and the motion compensated differential samples are added to the base layer samples corresponding to the enhancement layer samples that are being predicted. The second approach (also known as generalized residual prediction or base-layer enhanced motion compensation) forms motion compensated prediction on both base and enhancement layer, creates a differential component deducting the base layer motion compensation results from the base layer reconstructed samples and adds that differential component to the motion compensated enhancement layer samples.

Nevertheless, the existing solutions for scalable video coding do not take full advantage of the information available from the base layer and from the enhancement layer when encoding and decoding the enhancement layer.

Now in order to enhance the performance of the enhancement layer motion compensated prediction, an improved method for the prediction of enhancement layer samples is presented hereinafter.

In some embodiments the performance of the enhancement layer motion compensated prediction in reference frame based scalable video coding may be improved by placing a special type of frame to an enhancement layer decoded picture buffer and/or one or more reference picture lists of the enhancement layer and make the frame of the special type available in motion compensation process. In some embodiments the special type of frame is generated by obtaining motion parameters for a block of base layer samples; identifying a base layer reference picture for the block of base layer samples on the basis of the motion parameters; identifying an enhancement layer reference picture corresponding to a base layer reference picture; deriving a block of intermediate reference picture samples by using sample values of the base layer reference picture and sample values of the enhancement layer reference picture; and deriving a block of inter-layer reference picture samples by using the block of the intermediate reference picture samples and the block of base layer samples. In some embodiments the derived intermediate reference picture information is a motion compensated high frequency component wherein the special type of frame is generated by adding the motion compensated high frequency component from an enhancement layer to reconstructed sample values of the base layer.

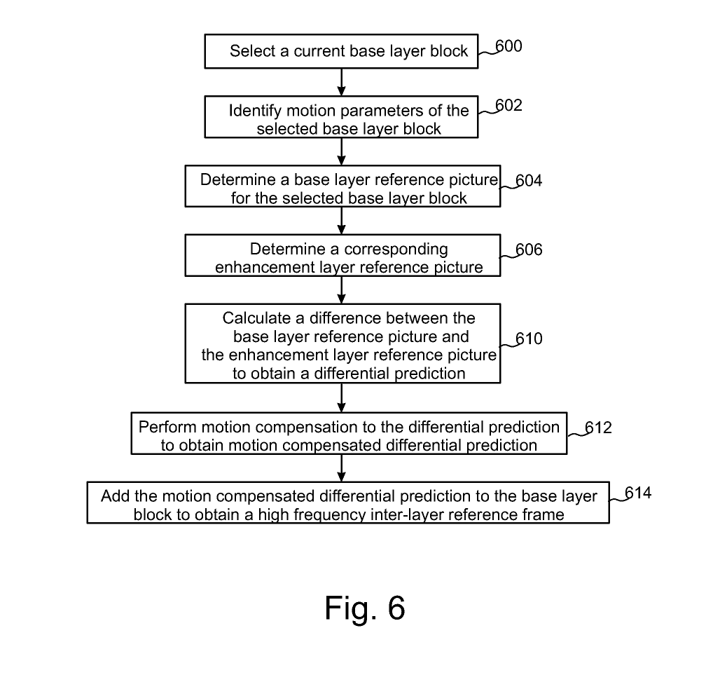

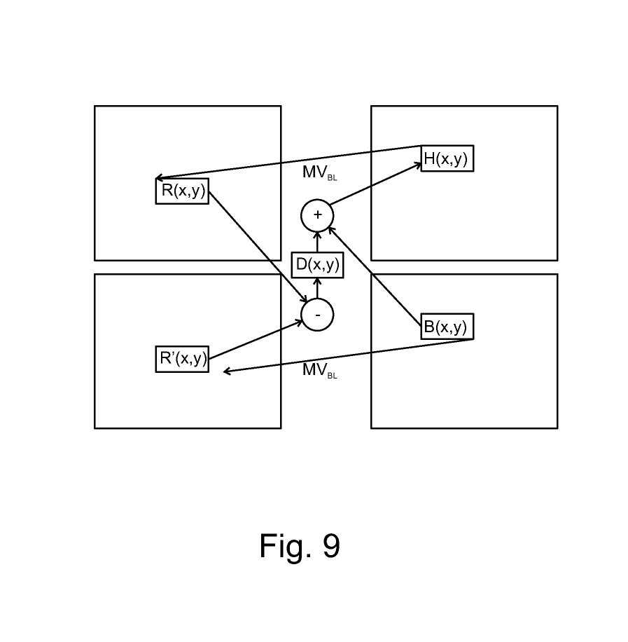

FIG. 9 depicts an example implementation for using a high frequency inter-layer reference (HILR) frame in motion compensated prediction and FIG. 6 discloses an example embodiment of a method. The motion compensation operation from the first layer and the second layer reference pictures may be uni-directional prediction or bi-directional prediction. The implementation may comprise the following steps.

For each block of HILR frame samples H(x, y), a block of base layer samples B(x, y) may be selected 600. Base layer motion parameters for the block of base layer samples B(x, y) may also be identified 602. The base layer motion parameters may include e.g. a motion vector MV_{BL} for the selected block. The motion parameters may be used to determine 604 a base layer reference picture R′, wherein the base layer reference picture R′ may be used to determine 606 a corresponding enhancement layer reference picture R. A differential reference picture may be calculated between the base layer reference picture R′ and the enhancement layer reference picture R may be calculated 606 and motion compensation 610 may be performed to obtain 612 a motion compensated differential prediction D(x, y) for the block of base layer samples by utilizing the motion parameters and differential reference picture. The motion compensated differential prediction values D(x, y) may be added 614 to the base layer samples B(x, y) to form a high frequency inter-layer reference samples H(x, y).

When the high frequency inter-layer reference frame sample block H(x, y) has been obtained it may be used as a reference in a motion compensated prediction process.

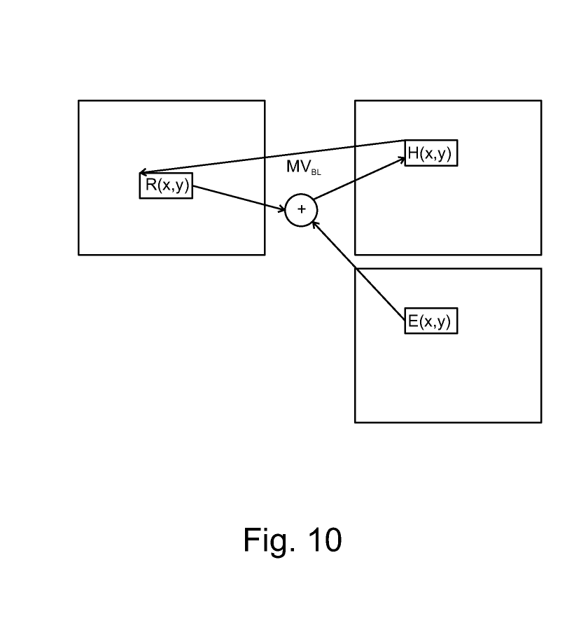

FIG. 10 depicts another example implementation for using high frequency inter-layer reference frames in motion compensated prediction. In this alternative implementation the H(x, y) samples in the high frequency inter-layer reference frame may be created by adding upsampled base layer prediction error to the samples obtained by performing a motion compensation operation in the enhancement layer using base layer motion parameters. In this case the implementation may comprise the following steps.

For each block of HILR frame samples H(x, y), a block of base layer samples E(x, y) may be selected 600. Base layer motion parameters for the block of base layer samples E(x, y) are identified. The base layer motion parameters may be received in a base layer bitstream and may include e.g. a motion vector MV_{BL} for the selected block. The base layer bitstream may also comprise indications identifying base layer residual samples E(x, y). A motion compensated prediction R(x, y) for the block of base layer samples E(x, y) may be calculated utilizing the motion parameters and sample values of an enhancement layer reference picture R. The motion compensated prediction R(x, y) may be added to the base layer residual samples E(x, y) to form a sample block H(x, y) of the high frequency inter-layer reference frame.

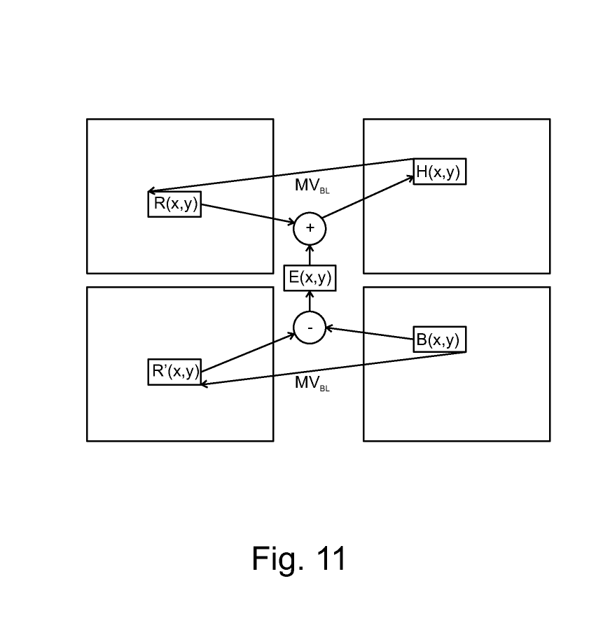

FIG. 11 depicts another implementation to obtain the high frequency inter-layer reference frames in motion compensated prediction. In this implementation a difference between the motion compensated block R′ (x, y) of the base layer reference picture R′ and the block of the base layer samples B(x, y) is calculated to obtain the motion compensated residual E(x, y) for the block of samples. The motion compensated residual E(x, y) represents therefore the base layer residual samples E(x, y) of the base layer block. The motion compensated residual values E(x, y) may be added 614 to motion compensated the sample values R(x, y) of the enhancement layer reference block to form the high frequency inter-layer reference frame sample block H(x, y).

When the high frequency inter-layer reference frame sample block H(x, y) has been obtained it may be used as a reference in a motion compensated prediction process.

In a yet another alternative implementation the following steps may be performed.

A differential reference picture DR may be derived. The differential reference picture DR may be sample-wise equal to the difference of sample values of a base layer reference picture R′ and sample values of a corresponding enhancement layer reference picture R. The differential reference picture may be derived for example using a conventional (de)coding process without residual coding. The differential reference picture may be marked as “used for (long-term or short-term) reference”, i.e. may be kept in a reference picture buffer.

In some embodiments the indication of the inter prediction modes and corresponding motion vectors and reference frame indexes may be done identical to the HEVC standard. The encoder may indicate usage of the HILR reference frame H by placing a corresponding reference or references to the HEVC reference index lists in any way allowed by the standard.

According to an embodiment, the encoder may indicate in the bitstream that the HILR reference frame H is not be output by the decoder. For example, the encoder may set a pic_output_flag, as specified in HEVC, equal to 0 for slices of the HILR reference frame.

In some embodiments the samples B(x,y) of the base layer picture and the samples R′(x,y) of the base layer reference picture may be generated by upsampling samples of the corresponding base layer images to have the same spatial resolution as the enhancement layer picture.

A base layer picture B(x,y) and its motion field may be upsampled as follows.

If the enhancement layer and base layer have a different spatial resolution, the base layer picture B(x,y) may be upsampled. In addition, a motion field associated with the upsampled base layer picture B(x,y) may be created, wherein the motion field comprises the decoded motion vectors of B(x,y) with a reference index or a POC difference or any other identification that identifies the differential reference picture DR(x,y). In the motion field creation the motion vectors may be scaled according to the spatial resolution ratio between the enhancement layer and the base layer. The potentially upsampled base layer picture B(x,y) and the created motion field are jointly denoted B′(x,y). The generation of the base layer picture B′(x,y) may be invoked by (de)coding of the HILR picture, for example.

Conventional upsampling and motion field generation/upsampling processes may be used in the generation of B′(x,y) except that the motion field upsampling may be directed to refer to differential picture(s) rather than the corresponding base layer picture(s). The encoder may encode indications in the bitstream and the decoder may decode indications from the bitstream concerning identification of the differential reference picture(s), e.g. one or more reference index differences or POC differences to be applied when converting a base layer reference picture identification to a reference picture identification in B′(x,y).

The (de)coding of a HILR may be done using a conventional scalable (de)coding scheme for example using one or more of the following steps or alike.

The encoder uses the B slice type. The encoder may indicate an advanced motion vector prediction (AMVP) or similar in the bitstream and the decoder may decode the use of AMVP or similar from the bitstream, where AMVP or similar may be used to form bi-prediction where the differential reference picture DR(x,y) is one reference and B′(x,y) is another reference.

Alternatively, the encoder may indicate the use of a merge mode or similar in the bitstream and the decoder may decode the use of the merge mode or similar from the bitstream, and the encoder and/or the decoder may use the merge mode or similar using one or more of the following steps or alike.

It is assumed that at least one spatial candidate for the merge mode or similar indicates a prediction from B′(x,y), which may be associated with a motion vector equal to 0. For example, the spatial candidate may have been coded with AMVP or similar where B′(x,y) may have been explicitly indicated as a prediction reference, or the spatial candidate may have been coded with merge mode and an index to a zero candidate (which is/are added at the end of a merge candidate list when no other candidates are available). The encoder may encode the bitstream in a manner that the collocated picture for the TMVP process or alike is set to B′(x,y) and the target picture for the TMVP process or alike is set to the differential reference picture DR(x,y). The decoding process may set the collocated picture and the target picture identically to what the encoder did.

Consequently, the TMVP candidate (or alike) in a motion vector prediction process corresponds to a prediction block from picture DR(x,y) obtained using the (potentially upscaled) base layer motion information.

When the number of candidates in a merge list is smaller than an indicated number after adding the spatial and temporal candidates, the merge mode prediction process may include bi-predictive candidates into the candidate list. Bi-predictive candidates may be generated by combining the first reference picture list motion parameters of an initial candidate with the second reference picture list motion parameters of another candidate. As a result of generation of bi-predictive candidates, a bi-predictive candidate combining a TMVP candidate (corresponding to a prediction block from the differential reference picture DR(x,y) obtained using the base layer motion) and a spatial candidate with zero motion from the base layer picture B′(x,y) may be generated.

The encoder may indicate the use of the bi-predictive candidate in the bitstream and the decoder may decode the use of the bi-predictive candidate from the bitstream.

No prediction residual/error may be (de)coded.

The HILR reference picture may be marked as “used for (long-term or short-term) reference”, i.e. the HILR reference picture may be kept in a reference picture buffer.

The HILR reference picture and/or the DR reference picture may be utilized in the prediction process of the current enhancement-layer picture. A conventional prediction process may be used, such as that of HEVC.

It should be noted here that the order of executing the steps presented above may vary and need not be executed in the same order than above.

The high frequency inter-layer reference frame may have the same or different picture order count (POC) value than B and R′ frames. The high frequency inter-layer reference frame may be indicated to reside in the enhancement layer, for example using a layer identifier value greater than 0, such as nuh_layer_id greater than 0.

In some embodiments, if the decoder outputs a high frequency inter-layer reference frame and if that frame resides in a highest layer for that picture order count or time instant, the rendering/displaying process may be adapted to ignore the high frequency inter-layer reference frame and render/display the picture on a layer below that layer containing the high frequency inter-layer reference frame.

Different approaches can be used to upsample the base layer picture B and base layer reference picture R′. For example, upsampling does not have to be done for complete pictures, but can be performed only for the areas needed in the motion compensation process.

Different approaches can be used to upsample the motion field of the base layer picture B(x,y). For example, motion field upsampling does not have to be done for motion fields of an entire picture, but can be performed only for the areas needed in the motion compensation process. In another example, a motion field is upsampled as part of motion vector prediction process, for example as part of deriving a TMVP candidate or alike. In yet another example, a motion field is upsampled through a function or process, which may be called as part of motion vector prediction process of one or more enhancement layer pictures e.g. when a TMVP candidate or alike is chosen as a motion vector predictor.

Instead of creating motion compensated differential prediction D(x, y) and adding it to the base layer reconstructed samples B(x, y), the samples in the HILR frame can be calculated performing individual motion compensations in the enhancement layer and the base layer. In this approach the samples of the HILR frame H(x, y) can be calculated as H(x, y)=P(x, y)−P′(x, y)+B(x, y), where P(x, y) and P′(x, y) refer to the enhancement layer and the base layer motion compensated prediction samples, respectively.

The high frequency inter-layer reference frame can be created by weighting components differently. E.g. all the enhancement and base layer components can have their own weights such as H(x, y)=w1*P(x, y)−w2*P′(x, y)+w3*B(x, y). One or more weights may be indicated by the encoder in the bitstream and decoded by the decoder from the bitstream. For example, such indications may be included in one or more syntax elements and/or syntax element values in a syntax structure such as a video parameter set, a sequence parameter set, a picture parameter, a slice header, or any other syntax structure. Alternatively or in addition, one or more weights by inferred by the encoder and the decoder and/or pre-defined e.g. in a coding standard.

There can be multiple high frequency inter-layer reference frames generated for a single picture to be decoded, for example all utilizing different weighting of the enhancement layer and base layer sample values when generating the different high frequency inter-layer reference frames.

In some embodiments, the high frequency inter-layer reference frames are not stored in the reference frame buffer and/or marked as “used for reference”, as they can be generated using the other reference frames stored in the base layer and enhancement layer reference frame buffers. In some embodiments, the encoder controls by one or more indications encoded in the bitstream and the decoder follows the encoder controls by decoding the one or more indications from the bitstream on which high frequency inter-layer reference frames are stored in the reference frame buffer and/or marked as “used for reference”. Furthermore, the encoder may include indications in the bitstream, such as indications which pictures are included in a reference picture set, and the decoder may decode said indications form the bitstream, to subsequently control which high frequency inter-layer reference frames are stored in the reference frame buffer and/or marked as “used for reference”.

Base layer prediction P′(x, y) can be stored in the memory during the base layer decoding and reused when calculating the HILR frames for the enhancement layer.

In addition to scalable video coding the high frequency inter-layer reference frames may also be utilized in multiview video coding.

Some embodiments for multiview video coding are described next. In multiview video coding a base layer and an enhancement layer in the above-described embodiments are different views. Views may be coded at different resolution and/or different quality. Consequently, one view may include a higher fidelity representation of some of the image content of another view. However, as the views represent different viewpoints, a differential representation should not generally be derived between samples of the same spatial coordinates, but rather disparity compensation may be applied. In different embodiments, a disparity may be applied to the base layer prediction blocks. For example, in the context of the first embodiment above, the following process may be applied for multiview coding similarly, where d stands for disparity:

Base layer motion parameters for a block of base layer samples B(x+d, y) may be identified and motion compensated differential prediction D(x, y) for the said block of samples may be calculated utilizing the motion parameters, sample values R′(x+d, y) of a base layer reference picture and sample values R(x, y) of a corresponding enhancement layer reference picture. The motion compensated differential prediction D(x, y) may be added to the base layer samples B(x+d, y) to form a HILR frame sample block H(x, y). The high frequency inter-layer reference frame sample block H(x, y) may be utilized as a reference in a motion compensated prediction process. In some embodiments, a disparity may be applied to the enhancement layer prediction blocks.

One embodiment presented above may be modified for multiview coding as follows. A disparity d′ may be taken into account in the derivation of the differential reference picture e.g. as follows: The sample values DR(x,y) of a differential reference picture is derived being sample-wise equal to the difference of sample values R′(x, y) of a base layer reference picture and sample values R(x+d′, y) of a corresponding enhancement layer reference picture.

In the derivation of the high frequency inter-layer reference picture a disparity may be coded as a (non-zero) motion vector used to derive a prediction from the base layer picture B′(x,y).

In some other embodiments, the disparity d or d′ may be derived for example using one or more of the following means.

An inter-view motion vector may be used as the disparity. In some embodiments, the derivation of a different reference picture DR(x,y) may be limited to anchor access units or similar where only inter-view prediction is enabled and no temporal prediction is in use for non-base views.

One or more disparity values may be determined by an encoder, e.g. using a disparity search, and indicated in the bitstream. A decoder may decode the one or more disparity values from the bitstream. The indicated disparity values may be specific to certain pictures and/or certain spatial areas.

In the case of depth-enhanced video coding, disparity values may be derived from the decoded/reconstructed depth pictures.

In various alternatives above, the generation of high frequency inter-layer reference frames may depend on the availability (as reference for prediction) of base layer reference picture(s) R′(x,y). The encoder may control the availability of R′(x,y) through reference picture sets for the base layer (and consequently reference picture marking for inter prediction of the base layer) and/or specific reference picture marking control for the high frequency inter-layer reference or for reference to a high frequency inter-layer reference frame H(x,y) or for inter-layer prediction in general. The encoder and/or the decoder may set the inter-layer marking status of a base layer (BL) picture R′(x,y) as “used for HILR reference” or “used for inter-layer reference” or alike when it is concluded that the base layer picture R′(x,y) is or may be needed as a high frequency inter-layer reference or an inter-layer prediction reference for an enhancement layer (EL) picture and as “unused for HILR reference” or “unused for inter-layer reference” or alike when it is concluded that the base layer picture R′(x,y) is not needed as a high frequency inter-layer reference or an inter-layer prediction reference for an enhancement layer picture.

The encoder may generate a specific reference picture set (RPS) syntax structure for inter-layer referencing or a part of another reference picture set syntax structure dedicated for inter-layer references. The syntax structure for inter-layer reference picture set may be appended to support inter-reference picture set prediction. As with other reference picture set syntax structures, each one of the inter-layer reference picture set syntax structures may be associated with an index and an index value may be included for example in a coded slice to indicate which inter-layer reference picture set is in use. The inter-layer reference picture set may indicate the base layer pictures, which are marked as “used for inter-layer reference”, while any base layer pictures not in the inter-layer reference picture set referred to be an enhancement layer picture may be marked as “unused for inter-layer reference”.

Alternatively or additionally, there may be other means to indicate if a base layer picture R′(x,y) is used for inter-layer reference, such as a flag in a slice header extension or in a slice extension of a coded slice of the base layer picture or in a coded slice of the respective enhancement layer picture. Furthermore, there may be one or more indications indicating the persistence of marking a base layer picture R′(x,y) as “used for inter-layer reference”, such as a counter syntax element in a sequence level syntax structure, such as a video parameter set, and/or in a picture or slice level structure, such as a slice extension. A sequence-level counter syntax element may for example indicate a maximum picture order count value difference of any enhancement layer motion vector that uses high frequency inter-layer reference and/or a maximum number of base layer pictures (which may be at the same or lower temporal sub-layer) in decoding order over which the base layer picture is marked as “used for inter-layer reference” (by the encoding and/or decoding process). A picture-level counter may for example indicate the number of base layer pictures (which may be at the same or lower temporal sub-layer as the base layer picture including the counter syntax element) in decoding order over which the base layer picture is marked as “used for inter-layer reference” (by the encoding and/or decoding process).

Alternatively or additionally, there may be other means to indicate which BL pictures are or may be used for inter-layer reference. For example, there may be a sequence-level indication, for example in a video parameter set, which temporal_id values and/or picture types in the base layer may be used as inter-layer reference, and/or which temporal_id values and/or picture types in the base layer are not used as inter-layer reference.

The decoded picture buffering (DPB) process may be modified in a manner that pictures, which are “used for reference” (for inter prediction), needed for output, or “used for inter-layer reference” are kept in the decoded picture buffer, while pictures which are “unused for reference” (for inter prediction), not needed for output (i.e. have already been output or were not intended for output in the first place), and are “unused for inter-layer reference” may be removed from the decoded picture buffer.

A decoder decoding only the base layer may omit processes related to marking of pictures as inter-layer references, e.g. decoding of the inter-layer reference picture set syntax structure, and hence treat all pictures as if they are “unused for inter-layer reference”.

Alternatively, in some embodiments the reference picture set syntax structure may be considered to operate layer-wise at least for short-term reference pictures, i.e. all short-term reference pictures that are in the same layer as the current picture and may be used as a reference for the current picture or any subsequent picture in decoding order in the same layer as the current picture are included in the reference picture set syntax structure. The reference picture set syntax structure that is valid for a picture at a first layer only causes marking of pictures at the same layer e.g. as “used for short-term reference”, “used for long-term reference”, or “unused for reference”. The availability of the base layer picture R′(x,y) for prediction of D(x,y) may therefore be controlled by the reference picture set syntax structure used for base layer pictures.

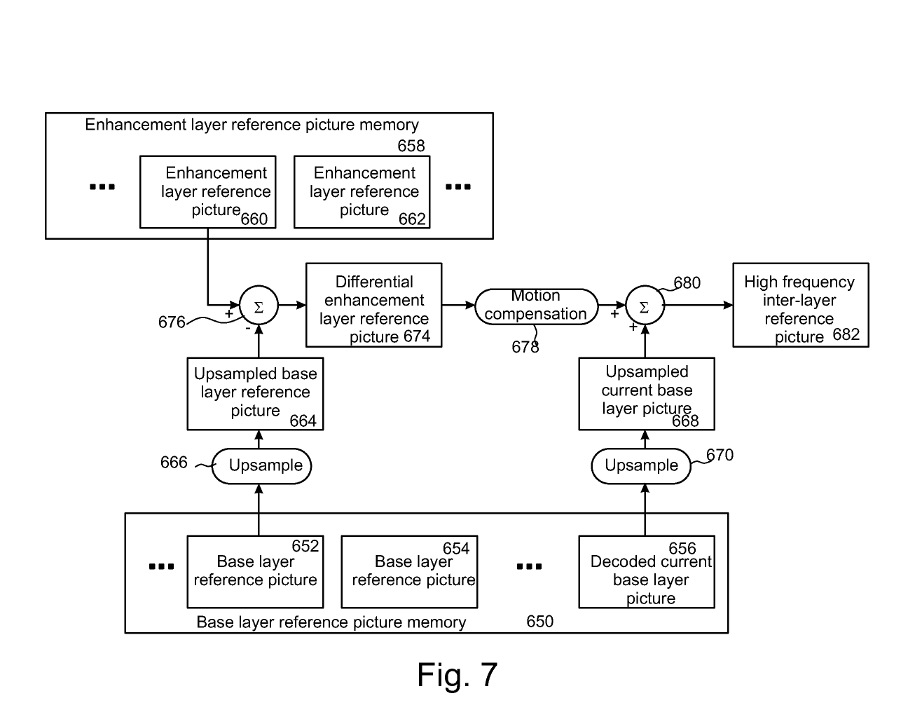

An embodiment for coding or decoding of a block of pixels in the enhancement layer (an enhancement layer block) is illustrated in the block chart of FIG. 7.

FIG. 7 discloses a base layer reference picture memory (650) comprising a plurality of base layer reference pictures R′_{N}, R′_{M}, . . . (652, 654), and a decoded current base layer picture B′ (656). Similarly, an enhancement layer reference picture memory (658) is disclosed, comprising a plurality of enhancement layer reference pictures R_{N}, R_{M}, . . . (660, 662).

In the process, an enhancement layer reference picture R_{N} (660) is identified. Also, an upsampled base layer reference picture R′(664) is identified, the upsampled base layer reference picture R′ (664) being upsampled (666) from the corresponding base layer reference picture R′_{N} (652) to have the same resolution as the enhancement layer reference picture R_{N} (660). Furthermore, an upsampled current base layer picture B (668) is identified, the upsampled current base layer picture B (668) being upsampled (670) from the decoded current base layer picture B′ (656) to have the same resolution as the enhancement layer reference picture R_{N} (660).

The sample values D(x,y) of a differential reference picture D (674) are created utilizing sample values R(x,y) of the enhancement layer reference picture R_{N} (660), sample values R′(x,y) of a corresponding base layer reference picture R′_{N} (652) and said offset value G: D(x,y)=clip(R(x,y)−R′(x,y)+G). In other words, the samples belonging to the upsampled base layer reference picture R′ (664) are deducted (676) from the corresponding samples of said enhancement layer reference picture R_{N} (660). The clip( ) function may be used to restrict the resulting sample value to the desired bit depth of the video material (e.g. in the range of 0-255, inclusive, for 8-bit video). Then a motion compensation process (678) is performed utilizing the differential reference picture D (674).

Next, the samples belonging to the upsampled current base layer picture B (668) are added (680) to the output of the motion compensation process (678). Hence, samples H(x,y) in a high frequency inter-layer reference picture H (682) are obtained as a result of the process. The high frequency inter-layer reference picture H may be stored to a reference frame memory, such as the enhancement layer reference picture memory 658.

A skilled man readily appreciates that the order of the above steps may vary. For example, identifying enhancement layer reference picture R_{N} (660), the upsampled base layer reference picture R′ (664) and the upsampled current base layer picture B (668) may be performed in any order. Also the signs of the summation steps may vary.

In the upsampling of the base layer, different upsampling filters may be utilized. The upsampling of the base layer may be done either for a complete picture or only for the area that is required for the motion compensation process (or an area in between).

According to an embodiment, the weighted prediction process can apply different weights as decided by the encoder algorithm.

According to an embodiment, there can be multiple differential reference pictures generated for a single picture to be decoded. For example, there can be one differential reference picture corresponding to each available traditional reference picture in the DPB buffer. The differential reference pictures do not necessarily have to be stored in the DPB buffer as they can be generated using the non-differential reference pictures stored in that buffer. The differential reference picture may also be created by scaling the differential component.

In various alternatives above, the generation of H(x,y) and/or DR(x,y) may depend on the availability (as reference for prediction) of base layer reference picture(s) R′(x,y). The encoder may control the availability of R′(x,y) through reference picture sets for the base layer (and consequently reference picture marking for inter prediction of the base layer) and/or specific reference picture marking control for BEMCP (base-enhanced motion-compensated prediction) or for reference to a differential reference frame D(x,y) or for inter-layer prediction in general. The encoder and/or the decoder may set the inter-layer marking status of a base layer BL picture R′(x,y) as “used for BEMCP reference” or “used for inter-layer reference” or alike when it is concluded that the BL picture R′(x,y) is or may be needed as a BEMCP reference or an inter-layer prediction reference for an enhancement layer EL picture and as “unused for BEMCP reference” or “unused for inter-layer reference” or alike when it is concluded that the BL picture R′(x,y) is not needed as a BEMCP reference or an inter-layer prediction reference for an EL picture.

The encoder may generate a specific reference picture set (RPS) syntax structure for inter-layer referencing and/or differential reference picture referencing or a part of another RPS syntax structure dedicated for inter-layer references and/or differential reference picture referencing. The syntax structure for inter-layer RPS may be appended to support inter-RPS prediction. As with other RPS syntax structures, each one of the inter-layer RPS syntax structures may be associated with an index and an index value may be included for example in a coded slice to indicate which inter-layer RPS is in use. The inter-layer RPS may indicate the base layer pictures and/or differential reference picture(s), which are marked as “used for inter-layer reference” and/or “used for differential reference” and/or alike, while any base layer picture and/or differential reference picture (or alike) not in the inter-layer RPS referred to be an EL picture may be marked as “unused for inter-layer reference” and/or “unused for differential reference” and/or alike.

Alternatively or additionally, there may be other means to indicate if a BL picture R′(x,y) is used for inter-layer reference, such as a flag in a slice extension of a coded slice of the BL picture or in a coded slice of the respective EL picture. Furthermore, there may be one or more indications indicating the persistence of marking a BL picture R′(x,y) as “used for inter-layer reference”, such as a counter syntax element in a sequence level syntax structure, such as a video parameter set, and/or in a picture or slice level structure, such as a slice extension. A sequence-level counter syntax element may for example indicate a maximum POC value difference of any EL motion vector that uses BEMCP and/or a maximum number of BL pictures (which may be at the same or lower temporal sub-layer) in decoding order over which the BL picture is marked as “used for inter-layer reference” (by the encoding and/or decoding process). A picture-level counter may for example indicate the number of BL pictures (which may be at the same or lower temporal sub-layer as the BL picture including the counter syntax element) in decoding order over which the BL picture is marked as “used for inter-layer reference” (by the encoding and/or decoding process).

Alternatively or additionally, there may be other means to indicate which BL pictures are or may be used for inter-layer reference. For example, there may be a sequence-level indication, for example in a video parameter set, which temporal_id values and/or picture types in the base layer may be used as inter-layer reference, and/or which temporal_id values and/or picture types in the base layer are not used as inter-layer reference.

Similarly to means and methods to control the marking and/or use and/or DPB storage of a BL picture R′(x,y) as inter-layer reference or alike, means and methods to control the marking and/or use and/or DPB storage of HILR picture H(x,y) and/or D(x,y) and/or DR(x,y) and/or B′(x,y) may be applied in various embodiments.

The decoded picture buffering (DPB) process may be modified in a manner that pictures, which are “used for reference” (for inter prediction), needed for output, or “used for inter-layer reference” are kept in the DPB, while pictures which are “unused for reference” (for inter prediction), not needed for output (i.e. have already been output or were not intended for output in the first place), and are “unused for inter-layer reference” (or alike) may be removed from the DPB. Any additional markings such as “unused for differential reference” may also be taken into account when removing pictures from the DPB.

A decoder decoding only the base layer may omit processes related to marking of pictures as inter-layer references, e.g. decoding of the inter-layer RPS, and hence treat all pictures as if they are “unused for inter-layer reference”.

Alternatively, in some embodiments the RPS may be considered to operate layer-wise at least for short-term reference pictures, i.e. all short-term reference pictures that are in the same layer as the current picture and may be used as a reference for the current picture or any subsequent picture in decoding order in the same layer as the current picture are included in the RPS. The RPS that is valid for a picture at a first layer only causes marking of pictures at the same layer e.g. as “used for short-term reference”, “used for long-term reference”, or “unused for reference”. The availability of the base layer picture R′(x,y) for obtaining H(x,y) may therefore be controlled by the RPS used for base layer pictures.

The above-described method can be applied to any video stream containing more than one representations of the content. For example, it can be applied to multi-view video coding utilizing possibly processed images from different views as the base images.

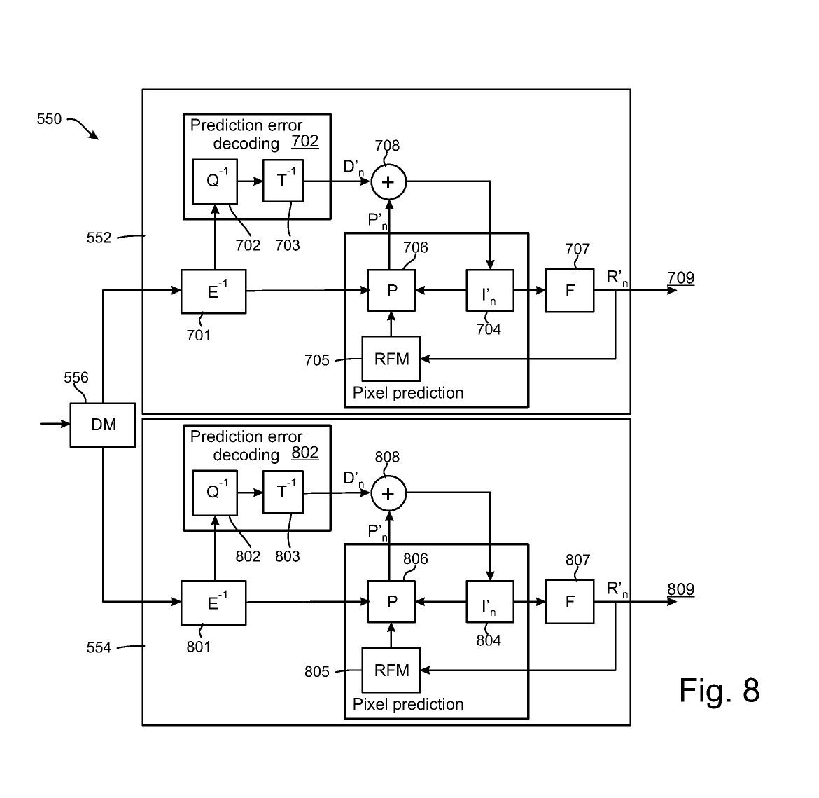

Another aspect of the invention is operation of the decoder when it receives the base-layer picture and at least one enhancement layer picture. FIG. 8 shows a block diagram of a video decoder suitable for employing embodiments of the invention.

The video decoder 550 comprises a first decoder section 552 for base view components and a second decoder section 554 for non-base view components. Block 556 illustrates a demultiplexer for delivering information regarding base view components to the first decoder section 552 and for delivering information regarding non-base view components to the second decoder section 554. Reference P′n stands for a predicted representation of an image block. Reference D′n stands for a reconstructed prediction error signal. Blocks 704, 804 illustrate preliminary reconstructed images (I′n). Reference R′n stands for a final reconstructed image. Blocks 703, 803 illustrate inverse transform (T⁻¹). Blocks 702, 802 illustrate inverse quantization (Q⁻¹). Blocks 701, 801 illustrate entropy decoding (E⁻¹). Blocks 705, 805 illustrate a reference frame memory (RFM). Blocks 706, 806 illustrate prediction (P) (either inter prediction or intra prediction). Blocks 707, 807 illustrate filtering (F). Blocks 708, 808 may be used to combine decoded prediction error information with predicted base view/non-base view components to obtain the preliminary reconstructed images (I′n). Preliminary reconstructed and filtered base view images may be output 709 from the first decoder section 552 and preliminary reconstructed and filtered base view images may be output 809 from the first decoder section 554.

The decoding operations of the embodiments are similar to the encoding operations, shown e.g. in FIG. 6. Thus, in the above process, the decoder may first create sample values of a differential reference picture by applying a filtering function to one or more enhancement layer reference pictures and one or more base layer reference pictures. The decoder identifies a block of samples to be predicted in the enhancement layer picture. Then, a motion compensation process is performed on a corresponding block of samples in said differential reference picture, and a motion compensated prediction is created for said samples to be predicted in the enhancement layer picture on the basis of samples of a corresponding base layer picture and the motion compensated samples of said differential reference picture.

If there is a residual signal resulting from the decoding of the block of samples, the decoder then decodes the residual signal into a reconstructed residual signal and adds the reconstructed residual signal to the decoded block in the enhancement layer picture.

In the above, some embodiments have been described with reference to an enhancement layer and a base layer. It needs to be understood that the base layer may as well be any other layer as long as it is a reference layer for the enhancement layer. It also needs to be understood that the encoder may generate more than two layers into a bitstream and the decoder may decode more than two layers from the bitstream. Embodiments could be realized with any pair of an enhancement layer and its reference layer. Likewise, many embodiments could be realized with consideration of more than two layers.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some or all common elements.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

A method according to a first embodiment comprises:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to an embodiment deriving the block of intermediate reference picture samples comprises calculating motion compensated differential prediction for the block of first layer samples utilizing the motion parameters, sample values of a first layer reference picture and sample values of a corresponding second layer reference picture.

According to an embodiment deriving the block of inter-layer reference picture comprises adding the motion compensated differential prediction to the first layer samples to form a high frequency inter-layer reference frame sample block.

According to an embodiment the high frequency inter-layer reference frame sample block is utilized as a reference in a motion compensated prediction process.

According to an embodiment deriving the block of high frequency inter-layer reference picture samples comprises:

obtaining a first layer prediction error;

adding the first layer prediction error to the samples of the second layer reference picture obtained by performing a motion compensation operation in the second layer.

According to an embodiment the method comprises upsampling the first layer prediction error before adding the first layer prediction error to the motion compensated second layer samples.

According to an embodiment the method comprises weighting the first layer samples by a first weighting factor; and weighting the sample values of the second layer reference picture by a second weighting factor.

According to an embodiment the method comprises storing the inter-layer reference picture into a reference memory.

According to an embodiment the method comprises indicating the block of inter-layer reference picture samples as not to be output by a decoder.

According to an embodiment the method comprises upsampling samples of the first layer reference picture and the samples of the block of the first layer samples before deriving the inter-layer reference picture.

According to an embodiment the block of inter-layer reference picture samples is received from a bitstream.

According to an embodiment the block of inter-layer reference picture samples is generated by a decoder for decoding a second layer picture.

According to an embodiment the first layer is a base layer and the second layer is an enhancement layer.

A method according to a second embodiment comprises:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to an embodiment the high frequency inter-layer reference frame sample block is utilized as a reference in a motion compensated prediction process.

According to an embodiment the method comprises upsampling the first layer prediction error before adding the first layer prediction error to the motion compensated sample values.

According to an embodiment the method comprises storing the inter-layer reference picture into a reference memory.

According to an embodiment the method comprises indicating the inter-layer reference picture as not to be output by a decoder.

According to an embodiment the method comprises:

upsampling the residual samples and the motion compensated sample values before deriving the inter-layer reference picture.

According to an embodiment the inter-layer reference picture is received from a bitstream.

According to an embodiment the inter-layer reference picture is generated by a decoder for decoding a second layer picture.

According to an embodiment the first layer is a base layer and the second layer is an enhancement layer.

According to a third embodiment there is provided at least one processor and at least one memory, said at least one memory stored with code thereon, which when executed by said at least one processor, causes an apparatus to perform:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to an embodiment said at least one memory stored with code thereon, which when executed by said at least one processor, causes the apparatus to calculate motion compensated differential prediction for the block of first layer samples utilizing the motion parameters, sample values of a first layer reference picture and sample values of a corresponding second layer reference picture.

According to an embodiment said at least one memory stored with code thereon, which when executed by said at least one processor, causes the apparatus to add the motion compensated differential prediction to the first layer samples to form a high frequency inter-layer reference frame sample block.

According to an embodiment said at least one memory stored with code thereon, which when executed by said at least one processor, causes the apparatus to utilize the high frequency inter-layer reference frame sample block as a reference in a motion compensated prediction process.

According to an embodiment said at least one memory stored with code thereon, which when executed by said at least one processor, causes the apparatus to:

obtain a first layer prediction error; and

add the first layer prediction error to the samples of the second layer reference picture obtained by performing a motion compensation operation in the second layer.

According to an embodiment said at least one memory stored with code thereon, which when executed by said at least one processor, causes the apparatus to upsample the first layer prediction error before adding the first layer prediction error to the motion compensated second layer samples.

According to an embodiment said at least one memory stored with code thereon, which when executed by said at least one processor, causes the apparatus to weight the first layer samples by a first weighting factor; and to weight the sample values of the second layer reference picture by a second weighting factor.

According to an embodiment said at least one memory stored with code thereon, which when executed by said at least one processor, causes the apparatus to store the block of inter-layer reference picture samples into a reference memory.

According to an embodiment said at least one memory stored with code thereon, which when executed by said at least one processor, causes the apparatus to indicate the block of inter-layer reference picture samples as not to be output by a decoder.

According to an embodiment said at least one memory stored with code thereon, which when executed by said at least one processor, causes the apparatus to receive an indication that the inter-layer reference picture is not to be output by a decoder.

According to an embodiment said at least one memory stored with code thereon, which when executed by said at least one processor, causes the apparatus to upsample samples of the first layer reference picture and the samples of the block of the first layer samples before deriving the inter-layer reference picture.

According to an embodiment said at least one memory stored with code thereon, which when executed by said at least one processor, causes the apparatus to insert the block of inter-layer reference picture samples into a bitstream.

According to an embodiment said at least one memory stored with code thereon, which when executed by said at least one processor, causes the apparatus to receive the block of inter-layer reference picture samples from a bitstream.

According to an embodiment said at least one memory stored with code thereon, which when executed by said at least one processor, causes the apparatus to generate the block of inter-layer reference picture samples for decoding a second layer picture.

According to an embodiment the first layer is a base layer and the second layer is an enhancement layer.

According to a fourth embodiment there is provided at least one processor and at least one memory, said at least one memory stored with code thereon, which when executed by said at least one processor, causes an apparatus to perform:

obtain motion parameters for a block of first layer samples;

identify a second layer reference picture corresponding to the first layer motion parameters;

derive a block of motion compensated sample values from the second layer reference picture on the basis of the motion parameters; and

derive an inter-layer reference block by using residual sample values of the block of first layer samples and the block of motion compensated sample values from the second layer reference picture.

According to an embodiment said at least one memory stored with code thereon, which when executed by said at least one processor, causes the apparatus to utilize the high frequency inter-layer reference frame sample block as a reference in a motion compensated prediction process.

According to an embodiment said at least one memory stored with code thereon, which when executed by said at least one processor, causes the apparatus to upsample the first layer prediction error before adding the first layer prediction error to the motion compensated sample values.

According to an embodiment said at least one memory stored with code thereon, which when executed by said at least one processor, causes the apparatus to store the inter-layer reference picture into a reference memory.

According to an embodiment said at least one memory stored with code thereon, which when executed by said at least one processor, causes the apparatus to indicate the inter-layer reference picture as not to be output by a decoder.

According to an embodiment said at least one memory stored with code thereon, which when executed by said at least one processor, causes the apparatus to upsample the residual samples and the motion compensated sample values before deriving the inter-layer reference picture.

According to an embodiment said at least one memory stored with code thereon, which when executed by said at least one processor, causes the apparatus to receive the inter-layer reference picture from a bitstream.

According to an embodiment said at least one memory stored with code thereon, which when executed by said at least one processor, causes the apparatus to generate the inter-layer reference picture by a decoder for decoding a second layer picture.

According to an embodiment the first layer is a base layer and the second layer is an enhancement layer.

According to a fifth embodiment there is provided a computer readable storage medium stored with code thereon for use by an apparatus, which when executed by a processor, causes the apparatus to perform:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a sixth embodiment there is provided a computer readable storage medium stored with code thereon for use by an apparatus, which when executed by a processor, causes the apparatus to perform:

obtain motion parameters for a block of first layer samples;

identify a second layer reference picture corresponding to the first layer motion parameters;

derive a block of motion compensated sample values from the second layer reference picture on the basis of the motion parameters; and

derive an inter-layer reference block by using residual sample values of the block of first layer samples and the block of motion compensated sample values from the second layer reference picture.

According to a seventh embodiment there is provided an apparatus comprising:

means for obtaining motion parameters for a block of first layer samples;

means for identifying a first layer reference picture for the block of first layer samples on the basis of the motion parameters;

means for identifying a second layer reference picture corresponding to the first layer reference picture;

means for deriving a block of intermediate reference picture samples by using sample values of the first layer reference picture and sample values of the second layer reference picture; and

means for deriving a block of inter-layer reference picture samples by using the intermediate reference picture samples and the block of first layer samples.

According to an eighth embodiment there is provided an apparatus comprising:

means for means for obtaining motion parameters for a block of first layer samples;

means for identifying a second layer reference picture corresponding to the first layer motion parameters;

means for deriving a block of motion compensated sample values from the second layer reference picture on the basis of the motion parameters; and

means for deriving an inter-layer reference block by using residual sample values of the block of first layer samples and the block of motion compensated sample values from the second layer reference picture.

According to a ninth embodiment there is provided an apparatus comprising a video encoder configured for encoding a scalable bitstream comprising at least a first layer and a second layer, wherein said video encoder is further configured for:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a tenth embodiment there is provided an apparatus comprising a video encoder configured for encoding a scalable bitstream comprising at least a first layer and a second layer, wherein said video encoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to an eleventh embodiment there is provided an apparatus comprising a video decoder configured for decoding a scalable bitstream comprising at least a first layer and a second layer, wherein said video decoder is further configured for:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to a twelfth embodiment there is provided an apparatus comprising a video decoder configured for decoding a scalable bitstream comprising at least a first layer and a second layer, wherein said video decoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to a thirteenth embodiment there is provided an encoder configured for encoding a scalable bitstream comprising at least a first layer and a second layer, wherein said encoder is further configured for:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer samples and sample values of the second layer reference picture; and

deriving a block of inter-layer reference picture samples by using the block of intermediate reference picture samples and the block of first layer samples.

According to an embodiment the encoder is further configured for deriving the block of intermediate reference picture samples by calculating motion compensated differential prediction for the block of first layer samples utilizing the motion parameters, sample values of a first layer reference picture and sample values of a corresponding second layer reference picture.

According to an embodiment the encoder is further configured for deriving the block of inter-layer reference picture samples by adding the motion compensated differential prediction to the first layer samples to form a high frequency inter-layer reference frame sample block.

According to an embodiment the encoder is further configured for utilizing the high frequency inter-layer reference frame sample block as a reference in a motion compensated prediction process.

According to an embodiment the encoder is further configured for deriving the block of high frequency inter-layer reference picture samples by:

obtaining a first layer prediction error;

adding the first layer prediction error to the samples of the second layer reference picture obtained by performing a motion compensation operation in the second layer.

According to an embodiment the encoder is further configured for upsampling the first layer prediction error before adding the first layer prediction error to the motion compensated second layer samples.

According to an embodiment the encoder is further configured for weighting the first layer samples by a first weighting factor; and weighting the sample values of the second layer reference picture by a second weighting factor.

According to an embodiment the encoder is further configured for storing the block of inter-layer reference picture samples into a reference memory.

According to an embodiment the encoder is further configured for indicating the block of inter-layer reference picture samples as not to be output by a decoder.

According to an embodiment the encoder is further configured for upsampling samples of the first layer reference picture and the samples of the block of the first layer samples before deriving the inter-layer reference picture.

According to an embodiment the encoder is further configured for inserting the block of inter-layer reference picture samples into a bitstream.

According to an embodiment the first layer is a base layer and the second layer is an enhancement layer.

According to a fourteenth embodiment there is provided an encoder configured for encoding a scalable bitstream comprising at least a first layer and a second layer, wherein said encoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to an embodiment the encoder is further configured for utilizing the high frequency inter-layer reference frame sample block as a reference in a motion compensated prediction process.

According to an embodiment the encoder is further configured for upsampling the first layer prediction error before adding the first layer prediction error to the motion compensated sample values.

According to an embodiment the encoder is further configured for storing the inter-layer reference picture into a reference memory.

According to an embodiment the encoder is further configured for indicating the inter-layer reference picture as not to be output by a decoder.

According to an embodiment the encoder is further configured for upsampling the residual samples and the motion compensated sample values before deriving the inter-layer reference picture.

According to an embodiment the first layer is a base layer and the second layer is an enhancement layer.

According to a fifteenth embodiment there is provided a decoder configured for decoding a scalable bitstream comprising a base layer and at least one enhancement layer, wherein said decoder is further configured for:

obtaining motion parameters for a block of first layer samples;

identifying a first layer reference picture for the block of first layer samples on the basis of the motion parameters;

identifying a second layer reference picture corresponding to the first layer reference picture;

deriving a block of intermediate reference picture samples by using sample values of the first layer reference picture and sample values of the second layer reference picture; and

deriving a block of inter-layer reference picture samples by using the block of intermediate reference picture samples and the block of first layer samples.

According to an embodiment the decoder is further configured for deriving the block of intermediate reference picture samples by calculating motion compensated differential prediction for the block of first layer samples utilizing the motion parameters, sample values of a first layer reference picture and sample values of a corresponding second layer reference picture.

According to an embodiment the decoder is further configured for deriving the block of inter-layer reference picture samples by adding the motion compensated differential prediction to the first layer samples to form a high frequency inter-layer reference frame sample block.

According to an embodiment the decoder is further configured for utilizing the high frequency inter-layer reference frame sample block as a reference in a motion compensated prediction process.

According to an embodiment the decoder is further configured for deriving the block of high frequency inter-layer reference picture samples by:

obtaining a first layer prediction error;

adding the first layer prediction error to the samples of the second layer reference picture obtained by performing a motion compensation operation in the second layer.

According to an embodiment the decoder is further configured for upsampling the first layer prediction error before adding the first layer prediction error to the motion compensated second layer samples.

According to an embodiment the decoder is further configured for weighting the first layer samples by a first weighting factor; and weighting the sample values of the second layer reference picture by a second weighting factor.

According to an embodiment the decoder is further configured for storing the block of inter-layer reference picture samples into a reference memory.

According to an embodiment the decoder is further configured for receiving an indication that the block of inter-layer reference picture samples is not to be output by the decoder.

According to an embodiment the decoder is further configured for upsampling samples of the first layer reference picture and the samples of the block of the first layer samples before deriving the inter-layer reference picture.

According to an embodiment the decoder is further configured for receiving the block of inter-layer reference picture samples from a bitstream.

According to an embodiment the decoder is further configured for generating the block of inter-layer reference picture samples for decoding a second layer picture.

According to an embodiment the first layer is a base layer and the second layer is an enhancement layer.

According to a sixteenth embodiment there is provided a decoder configured for decoding a scalable bitstream comprising a base layer and at least one enhancement layer, wherein said decoder is further configured for:

obtaining motion parameters for a block of first layer samples;

identifying a second layer reference picture corresponding to the first layer motion parameters;

deriving a block of motion compensated sample values from the second layer reference picture on the basis of the motion parameters; and

deriving an inter-layer reference block by using residual sample values of the block of first layer samples and the block of motion compensated sample values from the second layer reference picture.

According to an embodiment the decoder is further configured for utilizing the high frequency inter-layer reference frame sample block as a reference in a motion compensated prediction process.

According to an embodiment the decoder is further configured for upsampling the first layer prediction error before adding the first layer prediction error to the motion compensated sample values.

According to an embodiment the decoder is further configured for storing the inter-layer reference picture into a reference memory.

According to an embodiment the decoder is further configured for indicating the inter-layer reference picture as not to be output by a decoder.

According to an embodiment the decoder is further configured for:

upsampling the residual samples and the motion compensated sample values before deriving the inter-layer reference picture.

According to an embodiment the decoder is further configured for receiving the inter-layer reference picture from a bitstream.

According to an embodiment the decoder is further configured for generating the inter-layer reference picture by a decoder for decoding a second layer picture.

According to an embodiment the first layer is a base layer and the second layer is an enhancement layer.

We claim:

1. A method comprising:
obtaining motion parameters for a block of samples of a first layer;
identifying a reference picture of the first layer for the block of samples of the first layer on the basis of the motion parameters of the first layer;
identifying a reference picture of a second layer corresponding to the reference picture of the first layer;
deriving a block of intermediate reference picture samples by using sample values of the reference picture of the first layer and sample values of the reference picture of the second layer; and
deriving a block of inter-layer reference picture samples by using the block of intermediate reference picture samples and the block of samples of the first layer.

2. The method according to claim 1, wherein to derive the block of intermediate reference picture samples, the method comprises calculating motion compensated differential prediction for the block of samples of the first layer by utilizing the motion parameters, sample values of the reference picture of the first layer and sample values of a corresponding reference picture of the second layer.

3. The method according to claim 2 further comprising adding the motion compensated differential prediction to the samples of the first layer to form a high frequency inter-layer reference frame sample block.

4. The method according to claim 3 comprising utilizing the high frequency inter-layer reference frame sample block as a reference in a motion compensated prediction process.

5. The method according to claim 3, wherein deriving the block of high frequency inter-layer reference picture samples comprises:
obtaining a first layer prediction error;
adding the first layer prediction error to the samples of the reference picture of the second layer obtained by performing a motion compensation operation in the second layer.

6. The method according to claim 1, wherein the first layer is a base layer and the second layer is an enhancement layer.

7. The method according to claim 1, wherein the first layer represents a first view and the second layer represents a second view.

8. A method comprising:
obtaining motion parameters for a block of samples of the first layer;
identifying a reference picture of a second layer corresponding to the motion parameters of the first layer;
deriving a block of motion compensated sample values from the reference picture of the second layer on the basis of the motion parameters; and
deriving an inter-layer reference block by using residual sample values of the block of samples of the first layer and the block of motion compensated sample values from the reference picture of the second layer.

9. The method according to claim 8 comprising utilizing the high frequency inter-layer reference frame sample block as a reference in a motion compensated prediction process.

10. An apparatus comprising at least one processor and at least one memory, said at least one memory stored with code thereon, which when executed by said at least one processor, causes the apparatus to:
obtain motion parameters for a block of samples of a first layer;
identify a reference picture of the first layer for the block of samples of the first layer on the basis of the motion parameters of the first layer;
identify a reference picture of a second layer corresponding to the reference picture of the first layer;
derive a block of intermediate reference picture samples by using sample values of the reference picture of the first layer and sample values of the reference picture of the second layer; and
derive a block of inter-layer reference picture samples by using the block of intermediate reference picture samples and the block of samples of the first layer.

11. The apparatus according claim 10, said at least one memory stored with code thereon, which when executed by said at least one processor, causes the apparatus to calculate motion compensated differential prediction for the block of samples of the first layer utilizing the motion parameters, sample values of the reference picture of the first layer and sample values of a corresponding reference picture of the second layer.

12. The apparatus according claim 11, said at least one memory stored with code thereon, which when executed by said at least one processor, causes the apparatus to add the motion compensated differential prediction to the samples of the first layer to form a high frequency inter-layer reference frame sample block.

13. The apparatus according claim 12, said at least one memory stored with code thereon, which when executed by said at least one processor, causes the apparatus to utilize the high frequency inter-layer reference frame sample block as a reference in a motion compensated prediction process.

14. The apparatus according claim 10, said at least one memory stored with code thereon, which when executed by said at least one processor, causes the apparatus to indicate the block of inter-layer reference picture samples as not to be output by a decoder.

15. The apparatus according claim 10, said at least one memory stored with code thereon, which when executed by said at least one processor, causes the apparatus to receive an indication that the inter-layer reference picture is not to be output by a decoder.

16. The apparatus according claim 10, wherein the first layer is a base layer and the second layer is an enhancement layer.

17. The apparatus according claim 10, wherein the first layer represents a first view and the second layer represents a second view.

18. An apparatus comprising at least one processor and at least one memory, said at least one memory stored with code thereon, which when executed by said at least one processor, causes the apparatus to:
obtain motion parameters for a block of samples of a first layer;
identify a reference picture of a second layer corresponding to the motion parameters of the first layer;
derive a block of motion compensated sample values from the reference picture of the second layer on the basis of the motion parameters of the first layer; and
derive an inter-layer reference block by using residual sample values of the block of samples of the first layer and the block of motion compensated sample values from the reference picture of the second layer.

19. The apparatus according claim 18, said at least one memory stored with code thereon, which when executed by said at least one processor, causes the apparatus to utilize the high frequency inter-layer reference frame sample block as a reference in a motion compensated prediction process.

20. The apparatus according claim 18, wherein the first layer is a base layer and the second layer is an enhancement layer.

21. The apparatus according claim 18, wherein the first layer represents a first view and the second layer represents a second view.

22. A computer readable storage medium stored with code thereon for use by an apparatus, which when executed by a processor, causes the apparatus to:
obtain motion parameters for a block of samples of a first layer;
identify a first layer reference picture for the block of samples of the first layer on the basis of the motion parameters of the first layer;
identify a reference picture of a second layer corresponding to the reference picture of the first layer;
derive a block of intermediate reference picture samples by using sample values of the reference picture of the first layer and sample values of the reference picture of the second layer; and
derive a block of inter-layer reference picture samples by using the block of intermediate reference picture samples and the block of samples of the first layer.

23. A computer readable storage medium stored with code thereon for use by an apparatus, which when executed by a processor, causes the apparatus to:
obtain motion parameters for a block of samples of a first layer;
identify a reference picture of a second layer corresponding to the motion parameters of the first layer;
derive a block of motion compensated sample values from the reference picture of the second layer on the basis of the motion parameters of the first layer; and
derive an inter-layer reference block by using residual sample values of the block of samples of the first layer and the block of motion compensated sample values from the reference picture of the second layer.

24. An encoder configured for encoding a scalable bitstream comprising at least a first layer and a second layer, wherein said video encoder is further configured to:
obtain motion parameters for a block of samples of a first layer;
identify a reference picture of the first layer for the block of samples of the first layer on the basis of the motion parameters of the first layer;
identify a reference picture of a second layer corresponding to the reference picture of the first layer;
derive a block of intermediate reference picture samples by using sample values of the reference picture of the first layer and sample values of the reference picture of the second layer; and
derive a block of inter-layer reference picture samples by using the block of intermediate reference picture samples and the block of samples of the first layer.

25. A decoder configured for decoding a scalable bitstream comprising at least a first layer and a second layer, wherein said video decoder is further configured to:
obtain motion parameters for a block of samples of a first layer;
identify a reference picture of the first layer for the block of samples of the first layer on the basis of the motion parameters of the first layer;
identify a reference picture of a second layer corresponding to the reference picture of the first layer;
derive a block of intermediate reference picture samples by using sample values of the reference picture of the first layer and sample values of the reference picture of the second layer; and
derive a block of inter-layer reference picture samples by using the block of intermediate reference picture samples and the block of samples of the first layer.
